(19) United States
(12) Patent Application Publication
(10) Pub. No.: US 2024/0316485 A1
(43) Pub. Date: Sep. 26, 2024

(54) NO FILTER NO RUN FILTER CARTRIDGE

(71) Applicant: Cummins Filtration Inc., Nashville, TN (US)

(72) Inventors: Gerard Malgorn, Ergue (GA); Jayant Singh, Pune (IN); Wassem Abdalla, Fishers, IN (US); Mohseen Abdul Aziz Karche, Pune (IN); Ujjwala Ashish Lagad, Pune (IN); Navin Surana, Rainandgaon (IN); Ashutosh Joshi, Ahmedabad (IN); Sudhindra Palaxa Arakeri, Shahapur (IN); Pravin Shantinath Kadam, Jawahar Nagar (IN)

(73) Assignee: Cummins Filtration Inc., Nashville, TN (US)

(21) Appl. No.: 18/735,843

(22) Filed: Jun. 6, 2024

Related U.S. Application Data
(63) Continuation of application No. PCT/US2022/051986, filed on Dec. 6, 2022.

(30) Foreign Application Priority Data
Dec. 8, 2021 (IN) 202141057147
Apr. 22, 2022 (IN) 202241023769

(51) Int. Cl. B01D 35/30; B01D 29/11

(52) U.S. Cl. CPC B01D 35/30; B01D 29/11; B01D 2201/295; B01D 2201/304; B01D 2201/4092

(57) ABSTRACT

Various embodiments provide for a filter assembly including a filter head having one or more filter head threads and a filter cartridge. The filter cartridge includes a shell having a shell wall defining an internal volume and a collar disposed around and coupled to the shell, and a filter element. The collar includes one or more collar threads threadably engaged with the one or more filter head threads. The filter element is disposed within the internal volume. The filter element includes filter media and a first endplate coupled to the filter media at a filter media first end. The first endplate includes an endplate end wall and a first spacing member. The first spacing member extends axially away from the endplate end wall such that the first spacing member spaces the shell away from the filter head when the filter element is installed in the shell.

### CROSS-REFERENCE TO RELATED PATENT APPLICATIONS

This application claims is a continuation of PCT Application No. PCT/US2022/051986, filed Dec. 6, 2022, which claims priority to Indian Patent Application No. 202141057147, filed Dec. 8, 2021, and Indian Patent Application No. 202241023769, filed Apr. 22, 2022. The contents of these applications are incorporated herein by reference in their entirety.

### FIELD

The present application generally to fluid filtration assemblies for use in supplying filtered fluid to downstream devices.

### BACKGROUND

Internal combustion engines generally combust a mixture of fuel (e.g., diesel, gasoline, natural gas, etc.) and air. Prior to entering the engine, the fuel is typically passed through a filter cartridge to remove particulate matter (e.g., dust, metal particles, debris, etc.) from the fuel prior to combustion. Similarly, lubricant or lube (e.g., engine oil) provided to the engine may also be passed through a filter cartridge so as to remove particulate matter from the lube before communicating to the engine. The fuel or oil may include water, which may accumulate in the filter and may have to be removed.

Filter elements (e.g., filter cartridges) often include a sealing feature that forms a seal between the filter elements and a filter head. The seal prevents fluid from bypassing the filter element (e.g., for air to bypass an air filter element or liquid to bypass a liquid filter element). In many filter systems, if a filter element is not installed, unfiltered fluid may cause damage to downstream components. Accordingly, failure to install a filter element can harm critical components in the filtration system, diminish emission compliance mechanisms, cause subpar performance, and the like.

### SUMMARY OF THE INVENTION

Various embodiments provide for a filter assembly including a filter head having one or more filter head threads and a filter cartridge. The filter cartridge comprises a shell and a filter element. The shell has a shell wall defining an internal volume and a collar disposed around and coupled to the shell. The collar includes one or more collar threads threadably engaged with the one or more filter head threads. The filter element is disposed within the internal volume. The filter element includes filter media and a first endplate coupled to the filter media at a filter media first end. The first endplate includes an endplate end wall and a first spacing member. The first spacing member extends axially away from the endplate end wall such that the first spacing member spaces the shell away from the filter head when the filter element is installed in the shell.

Various other example embodiments provide for a method of installing a filter cartridge with a filter head. The method includes threadably engaging a collar thread of a collar of the filter cartridge with a filter head thread of the filter head. The method also includes spacing, by a first spacing member having a first axial length, a shell away from the filter head by the first axial length.

These and other features, together with the organization and manner of operation thereof, will become apparent from the following detailed description when taken in conjunction with the accompanying drawings, wherein like elements have like numerals throughout the several drawings described below

### BRIEF DESCRIPTION OF THE DRAWINGS

FIG. 1 is a cross-sectional view of a filter assembly, according to an example embodiment.

FIG. 2A is a detailed cross-sectional view of a portion of the filter assembly of FIG. 1 shown with a filter element.

FIG. 2B is a detailed cross-sectional view of a portion of the filter assembly of FIG. 1 shown without a filter element.

FIG. 3 is a perspective view of a collar for the filter assembly of FIG. 1.

FIG. 4A is a side view of the filter assembly of FIG. 1 shown with a filter element installed.

FIG. 4B is a side view of the filter assembly of FIG. 1 shown without a filter element installed.

FIG. 5 is a perspective view of a filter element for the filter assembly of FIG. 1.

FIG. 6 is a perspective view of a filter cartridge for the filter assembly of FIG. 1.

FIG. 7A is a cross-sectional view of a filter assembly, according to another example embodiment.

FIG. 7B is a detailed cross-sectional view of a portion of the filter assembly of FIG. 7A.

FIG. 8 is a detailed cross-sectional view of a portion of the filter assembly of FIG. 7A without a filter element installed therein.

FIG. 9 is a perspective view of a shell for the filter assembly of FIG. 7A.

FIG. 10 is a cross-sectional view of a filter assembly, according to another example embodiment.

FIG. 11A is a detailed cross-sectional view of a portion of the filter assembly of FIG. 10.

FIG. 11B is a perspective cross-sectional view of a portion of the filter assembly of FIG. 10.

FIG. 12 is a detailed cross-sectional view of a portion of the filter assembly of FIG. 10 without a filter element installed therein.

FIG. 13 is a cross-sectional view of a filter assembly having a filter element, according to an example embodiment.

FIG. 14 is a detailed cross-sectional view of the filter assembly of FIG. 13.

FIG. 15 is a detailed cross-sectional view of the filter assembly of FIG. 13 with an alternative filter element, according to an example embodiment.

FIG. 16 is a top perspective view of a second endplate of the filter assembly of FIGS. 13 and 14.

FIG. 17 is a bottom perspective view of the second endplate of FIG. 16.

FIG. 18 is a detailed cross-sectional view of the filter assembly of FIGS. 13 and 14 having the second endplate of FIGS. 16 and 17.

FIG. 19 is a top perspective view of an alternative second endplate for use in the filter assembly of FIGS. 13-15.

FIG. 20 is a detailed cross-sectional view of the filter assembly of FIGS. 13-15 having the alternative second endplate of FIG. 19.

FIG. 21 is a top view of the filter assembly of FIGS. 13-15 without a filter head and having the alternative second endplate of FIG. 19.

FIG. 22 is a top perspective view of an alternative second endplate for use with the filter assembly of FIGS. 13-15.

FIG. 23 is a cross-sectional view of the alternative second endplate of FIG. 22.

FIG. 24 is a top perspective view of an endplate body portion of the alternative second endplate of FIG. 22.

FIG. 25 is a top perspective view of a spacing member of the alternative second endplate of FIG. 22.

FIG. 26 is a top perspective view of an alternative second endplate usable with the filter assembly of FIGS. 13-15.

FIG. 27 is a detailed cross-sectional view of the alternative second endplate of FIG. 26 at line BB of FIG. 26.

FIG. 28 is a top perspective view of an endplate body portion of the alternative second endplate of FIG. 26.

FIG. 29 is a top perspective view of a spacing portion of the alternative second endplate of FIG. 26.

FIG. 30 is a top perspective view of an alternative second endplate usable with the filter assembly of FIGS. 13-15.

FIG. 31 is a detailed cross-sectional view of the alternative second endplate of FIG. 30.

FIG. 32 is a top perspective view of an endplate body portion of the alternative second endplate of FIG. 30.

FIG. 33 is a top perspective view of a spacing portion of the alternative second endplate of FIG. 30.

FIG. 34 is a detailed cross-sectional view of an alternative filter element installed within the filter assembly of FIG. 13.

FIG. 35 is a top perspective view of the alternative filter element of FIG. 34 having an alternative second endplate usable with the filter assembly of FIGS. 13-15.

FIG. 36 is a top perspective view of an endplate body portion of the alternative second endplate of FIG. 35.

FIG. 37 is a top perspective view of a spacing portion of the alternative second endplate of FIG. 35.

FIG. 38 is a detailed cross-sectional view of an alternative filter element installed within the filter assembly of FIG. 13.

FIG. 39 is a top perspective view of an alternative second endplate of the alternative filter element of FIG. 38 usable with the filter assembly of FIGS. 13-15.

FIG. 40 is a detailed cross-sectional view of the filter assembly of FIG. 13 at view window AA is shown, the filter assembly having an example configuration of the alternative second endplate of FIG. 39, which is usable with the filter assembly of FIGS. 13-15.

FIG. 41 is a detailed cross-sectional view of the filter assembly of FIG. 13 at view window AA is shown, the filter assembly having another example configuration of the alternative second endplate of FIG. 39 usable with the filter assembly of FIGS. 13-15.

FIG. 42 is a detailed cross-sectional view of the filter assembly of FIG. 13 at view window AA is shown, the filter assembly having another example configuration of the alternative second endplate of FIG. 39 usable with the filter assembly of FIGS. 13-15.

FIG. 43 is a detailed cross-sectional view of the filter assembly of FIG. 13 at view window AA is shown, the filter assembly having another example configuration of the alternative second endplate of FIG. 39 usable with the filter assembly of FIGS. 13-15.

FIG. 44 is a detailed cross-sectional view of a portion of a filter assembly including an alternative filter element.

FIG. 45 is a detailed cross-sectional view of a portion of a filter assembly including still another alternative filter element.

FIG. 46 is a side view of a filter assembly including yet another alternative filter element.

FIG. 47 is another side view of the filter assembly of FIG. 46.

FIG. 48 is a perspective view of the filter assembly of FIG. 46.

FIG. 49 is a perspective view of the filter assembly of FIG. 46, shown in a disassembled state.

FIG. 50 is a perspective view of the filter element usable in the filter assembly of FIG. 46.

FIG. 51 is a side view of the filter element of FIG. 50.

FIG. 52 is a perspective view of the filter element of FIG. 50, shown in a disassembled state.

FIG. 53 is a side view showing a portion of the filter element of FIG. 50.

FIG. 54 is a cross sectional view of the filter assembly of FIG. 46.

FIG. 55 is a detailed cross sectional view of the filter assembly of FIG. 46, shown with the filter element of FIG. 50.

FIG. 56 is a detailed cross sectional view of the filter assembly of FIG. 46, shown without a filter element.

### DETAILED DESCRIPTION

Embodiments described herein relate generally to a no-filter no-run filter assembly. In some embodiments, the filter element assembly includes a no-filter no-run feature configured to visually demonstrate whether a filter element is installed in the filter assembly. The no-filter no-run feature is also configured to operationally prevent a downstream device, such as an engine, from operating when a filter element is not installed. The no-filter no-run feature advantageously improves the ease of serviceability by ensuring that the filter element is properly installed within the filter assembly.

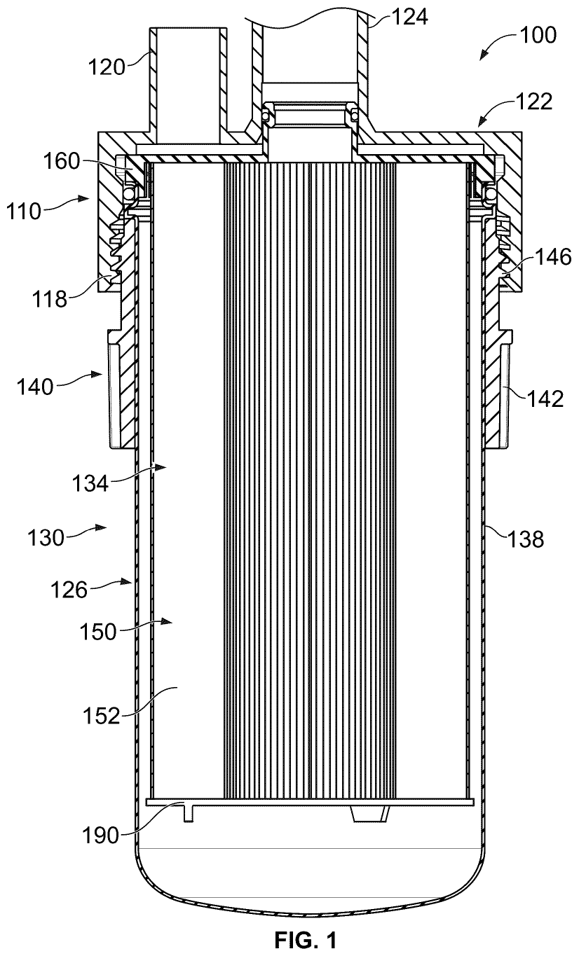

Referring to FIG. 1, a cross-sectional view of a filter assembly 100 is shown, according to an example embodiment. The filter assembly 100 includes a filter head 110 and a filter cartridge 130 removably coupled to the filter head 110. It should be understood that the filter assembly 100 may include more or fewer components than as shown in FIG. 1.

The filter head 110 includes a filter head wall 122. The filter head 110 includes a first port 120 and a second port 124. One of the first port 120 and the second port 124 is an inlet, and the other of the first port 120 and the second port 124 is an outlet. For example, in particular embodiments the first port 120 is an inlet for providing a dirty or unfiltered fuel to the filter assembly 100, and the second port 124 is an outlet for providing a filtered fuel to a downstream component such as an engine. The filter head 110 also includes one or more inward facing threads shown as filter head threads 118. The filter head threads 118 are configured to receive one or more outward facing threads, such as one or more outward facing treads shown as collar threads of the collar 140 (described herein below).

The filter cartridge 130 includes a shell 138, a collar 140, and a filter element 150. The shell has a shell wall 126. The shell 138 defines an internal volume 134. In various embodiments, the shell wall 126 is unitarily formed with the collar 140. Accordingly, as used herein the “shell 138” may refer to the shell wall 126 and/or the collar 140. In various embodiments, the filter element 150 is removably positioned within the shell 138. The shell 138 is structured to receive the filter element 150 at least partially within the internal volume 134.

The collar 140 includes a grip surface 142 and the collar threads 148. The collar 140 couples the filter cartridge 130 to the filter head 110 by threadably engaging the collar threads 148 with the filter head threads 118. The grip surface 142 provides a surface for a user to hold when threading the filter cartridge 130 to the filter head 110.

The filter element 150 includes a filter media 152 fitted between a first endplate 160 and a second endplate 190. For example the first endplate 160 is coupled to the filter media 152 at a filter media first end, and the second endplate 190 is coupled to the filter media 152 at a filter media second end, opposite the first end. The filter media 152 may include one or more media layers such as a pleated and/or a woven or non-woven filter media, a hydrophobic screen, and/or any other suitable filter media layer.

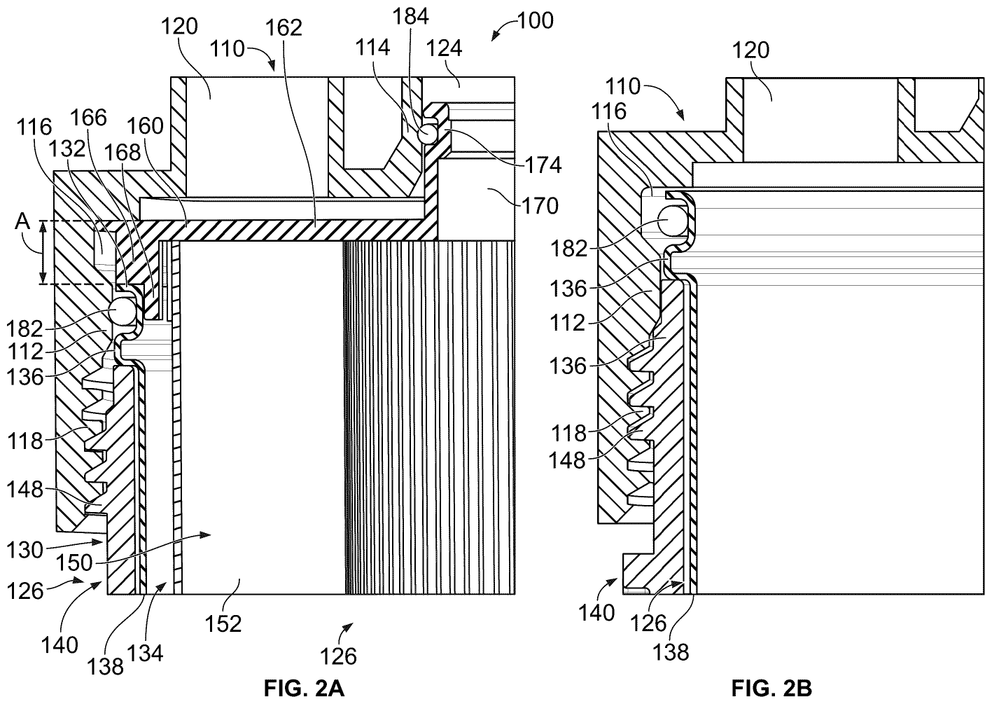

FIG. 2A is a detailed cross-sectional view of a portion of the filter assembly 100, shown with a filter element 150 installed (e.g., within the shell 138). As shown, the filter head 110 includes a first sealing surface 112, a second sealing surface 114, a recessed wall 116, and the filter head threads 118. The filter head 110 also includes the first port 120 and the second port 124 (described herein above). The first sealing surface 112 is structured to form a first circumferential, radially-directed seal with a sealing member (e.g., a first sealing member 182 in the form of an o-ring gasket or the like). The second sealing surface 114 is structured to form a second circumferential seal with a sealing member (e.g., a second sealing member 184 in the form of an o-ring gasket or the like). The recessed wall 116 is a portion of a side wall of the filter head 110 that is positioned farther away from the filter element 150 (when installed) than the portion of the filter head defined by the first sealing surface 112. In the embodiment shown in FIG. 2A, the first sealing surface 112 and the recessed wall 116 are positioned axially above the filter head threads 118.

In some embodiments, the recessed wall 116 is part of a third port of the filter head 110. The third port may be disposed on an outer surface of the filter head 110, radially outside of the first endplate 160, and extend axially through the filter head 110 toward the first sealing surface 112. In some embodiments, the third port at least partially defines the recessed wall 116 such that the recessed wall 116 is formed without the need for additional machining.

The shell 138 includes a shell sealing channel 132 configured to receive the first sealing member 182 therein. The first sealing member 182 is structured to form a first circumferential seal between the shell 138 (e.g., at the shell sealing channel 132) and the filter head 110 (e.g., at the first sealing surface 112). Accordingly, the first circumferential seal substantially prevents a fluid from flowing between the shell 138 and the filter head 110. The shell 138 also includes a circumferential flange 136 for coupling the shell 138 to the collar 140. The shell sealing channel 132 is positioned axially above the collar threads 148.

The filter cartridge 130 is shown in FIG. 2A having the filter element 150 installed within the internal volume 134 of the shell 138. The first endplate 160 of the filter element 150 includes an endplate end wall 162, a first spacing member 166, a second spacing member 168, and an axial channel 170. The first endplate 160 is fixed to the filter media 152 at the endplate end wall 162.

The first spacing member 166 has a first dimension that extends radially way from the endplate end wall 162 and a second dimension that extends axially away from the endplate end wall 162. The first spacing member 166 extends in the second dimension a predetermined length (A) away from the endplate end wall 162 such that the first spacing member 166 spaces a top portion of the shell 138 away from the filter head 100. More specifically, the first spacing member spaces the shell sealing channel 132 away from the recessed wall 116 by the length (A). For example, when the filter cartridge 130 is threaded onto the filter head 110, the first spacing member 166 is positioned within the recessed wall 116. The first sealing member 182 is aligned with the first sealing surface 112. The first spacing member 166 substantially prevents the filter cartridge 130 form being further threaded such that the first sealing member 182 and the shell sealing channel 132 are substantially prevented from moving into the recessed wall 116 of the filter head 110. That is, when the filter element 150 is installed in the shell 138, the collar threads 148 engage with the filter head threads 118 until prevented by the first spacing member 166. In the embodiment shown in FIG. 2A, the first spacing member 166 is unitarily formed with the second spacing member 168 such that the first spacing member 166 extends radially away from the second spacing member 168 along the first dimension.

The second spacing member 168 has a first dimension extending axially away from the endplate end wall 162 and a second dimension extending in a circumferential direction such that the second spacing member 168 is, at least partially, curved. A radially outer surface of the second spacing member 168 contacts the shell 138 (e.g., at the shell sealing channel 132) such that the second spacing member 168 locates the filter element 150 at a center of the internal volume 134 of the shell 138. The axial channel 170 extends axially way from the endplate end wall 162. The axial channel 170 is in fluid communication with the second port 124. The axial channel 170 includes an endplate sealing channel 174. The endplate sealing channel 174 is structured to receive a second sealing member 184 therein. The second sealing member 184 is structured to form a circumferential seal between the first endplate 160 (e.g., at the endplate scaling channel 174) and the filter head 110 (e.g., at the second sealing surface 114).

In some embodiments, when the first circumferential seal is formed by the first sealing member 182, at least one of an upstream component and a downstream component are structured to operate normally. For example, at least one of the upstream component and the downstream component may detect the presence of the seal by detecting a fluid pressure within a predetermined threshold. The first circumferential seal maintains the fluid pressure by substantially preventing a fluid from entering the internal volume 134 from outside the filter assembly 100 and/or escaping from the internal volume 134 to the outside of the filter assembly 100. In other embodiments, when the first circumferential seal is formed by the first sealing member 182, a user may visually inspect the filter assembly 100 to verify that no fluid is leaking out of the filter assembly 100.

FIG. 2B is a detailed cross-sectional view of the filter assembly 100 of FIG. 1 shown without a filter element 150. When the first spacing member 166 is not present, the collar threads 148 engage with the filter head threads 118 until the first sealing member 182 is positioned within the recessed wall 116. The first sealing member 182 does not form a seal with the recessed wall 116 such that a fluid may flow between the shell 138 and the filter head 110.

In some embodiments, when the first circumferential seal is not formed by the first sealing member 182, at least one of an upstream component and a downstream component are structured to be prevented from operating normally. For example at least one of the upstream component and the downstream component may detect the absence of the seal by detecting a fluid pressure outside of a predetermined threshold. The fluid pressure within the filter assembly 100 cannot be maintained because the outside of the filter assembly 100 is in fluid communication with the internal volume 134. In other embodiments, when the first circumferential seal is not formed by the first sealing member 182, a user may visually inspect the filter assembly 100 to determine that a fluid is leaking out of the filter assembly 100.

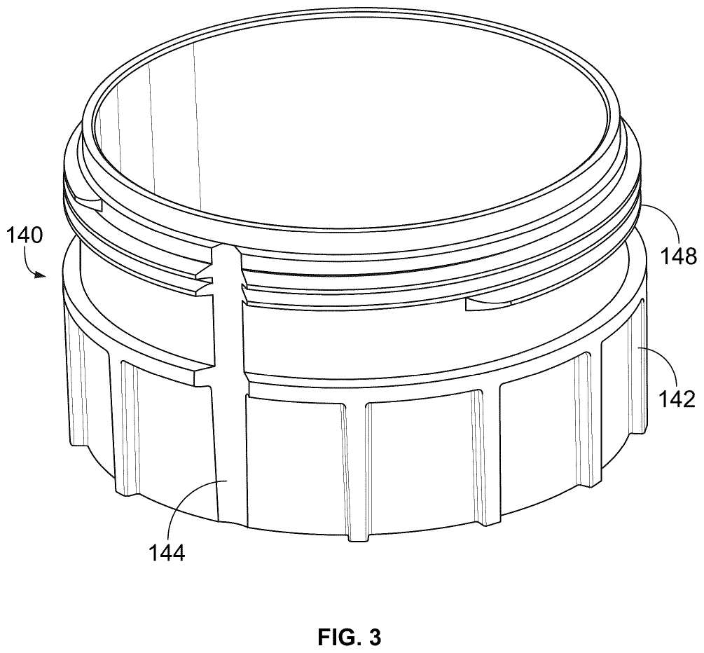

FIG. 3 is a perspective view of a collar 140 for the filter assembly of FIG. 1. The grip surface 142 extends at least partially around the circumference of the collar 140. The collar threads 148 extend at least partially around the circumference of the collar 140. The collar 140 also includes a collar axial channel 144 that provides fluid communication through the exterior of the collar 140 (e.g., through the grip surface 142 and/or through the collar threads 148). For example, the collar axial channel 144 fluidly couples the internal volume of the shell 138 with an exterior of the filter assembly 100 when the first circumferential seal is not formed between the shell 138 and the filter head 110 by the first sealing member 182 (as shown in FIG. 2B). When the first circumferential seal is formed between the shell 138 and the filter head 110 by the first scaling member 182 (as shown in FIG. 2A), the first circumferential seal substantially prevents fluid communication between the internal volume of the shell 138 and an exterior of the filter assembly 100 through the collar axial channel 144.

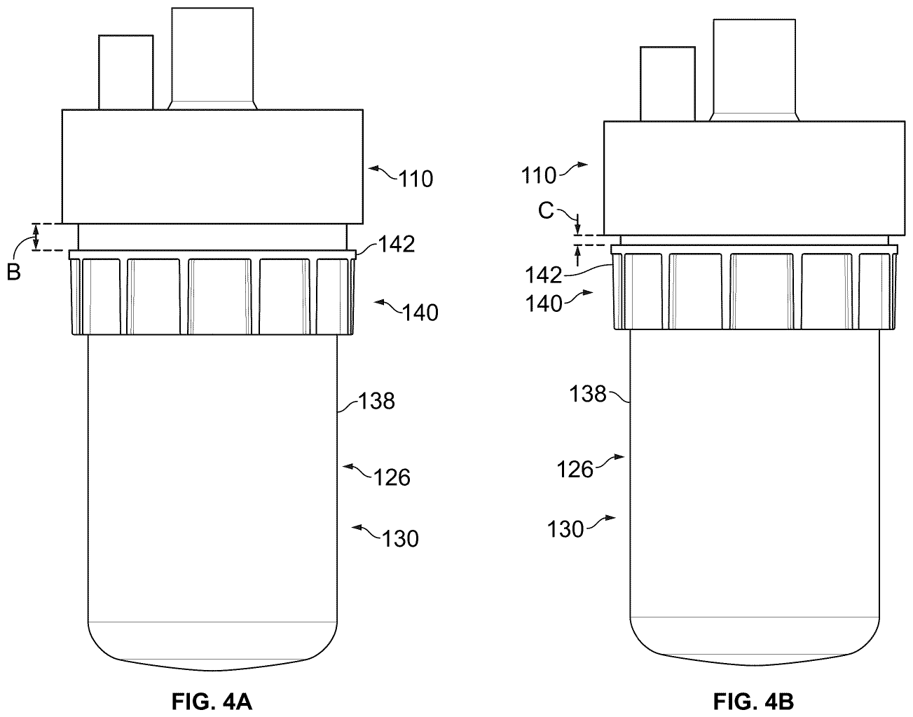

Now referring to FIGS. 4A and 4B, side views of the filter assembly 100 of FIG. 1 are shown. FIG. 4A is a side view of the filter assembly 100 of FIG. 1 shown with a filter element 150 installed (within the shell 138). When the filter element 150 is installed and the first spacing member 166 is prevents the first sealing member 182 from moving past the first sealing surface 112 (as shown in FIG. 2A), the grip surface is a distance (B) away from the filter head 110. FIG. 4B is a side view of the filter assembly 100 of FIG. 1 shown without a filter element 150 installed. When the filter element 150 is not installed within the shell 138, and the first sealing member 182 is allowed to move past the first sealing surface 112 (as shown in FIG. 2A) the grip surface is a distance (C) away from the filter head 110. The distance B is visually greater than the distance (C) such that a user may visually determine, based on the visual difference, whether a filter element 150 is installed within the filter assembly 100.

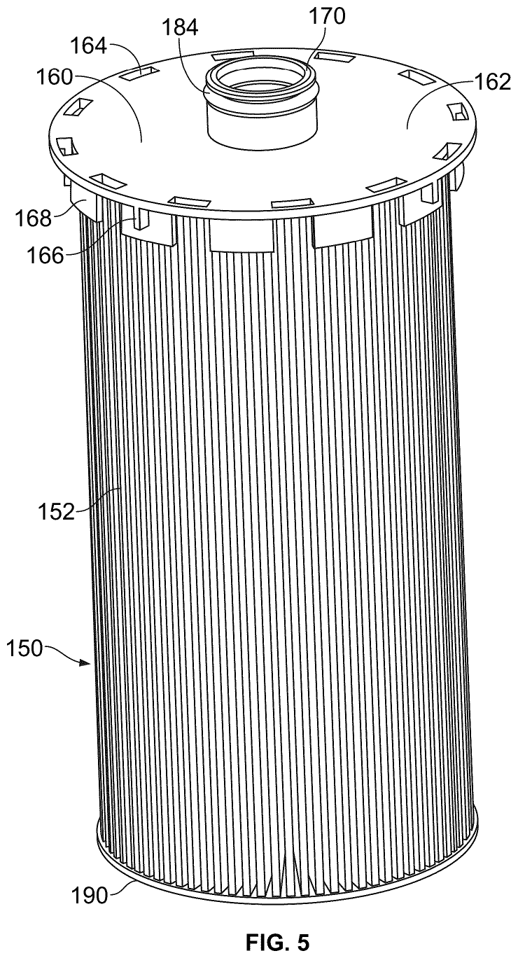

FIG. 5 is a perspective view of a filter element 150 for the filter assembly of FIG. 1. The first endplate 160 is shown to further include one or more openings 164 formed through the endplate end wall 162. The one or more openings 164 provide fluid communication between the first port 120 and the filter media 152. The first endplate 160 also includes a plurality of first spacing members 166 disposed around a perimeter of the endplate end wall 162. The first endplate 160 also includes a plurality of second spacing members 168 disposed around a perimeter of the endplate end wall 162. Each first spacing member 166 of the plurality of first spacing members 166 is coupled to (e.g., integrally formed with) one of the second spacing members 168 of the plurality of second spacing members 168.

FIG. 6 is a perspective view of a filter cartridge 130 for the filter assembly 100 of FIG. 1. As shown, the filter cartridge 130 has a filter element 150 installed within the shell 138.

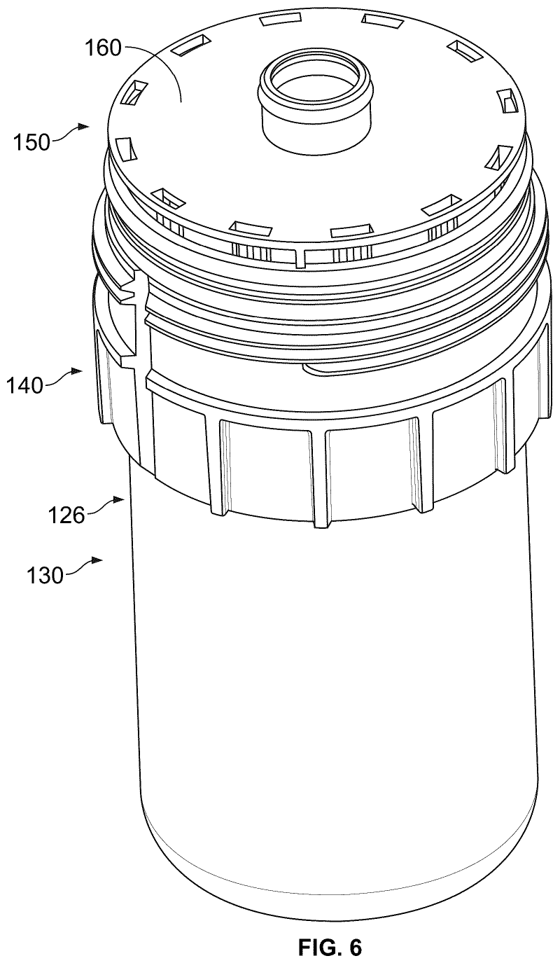

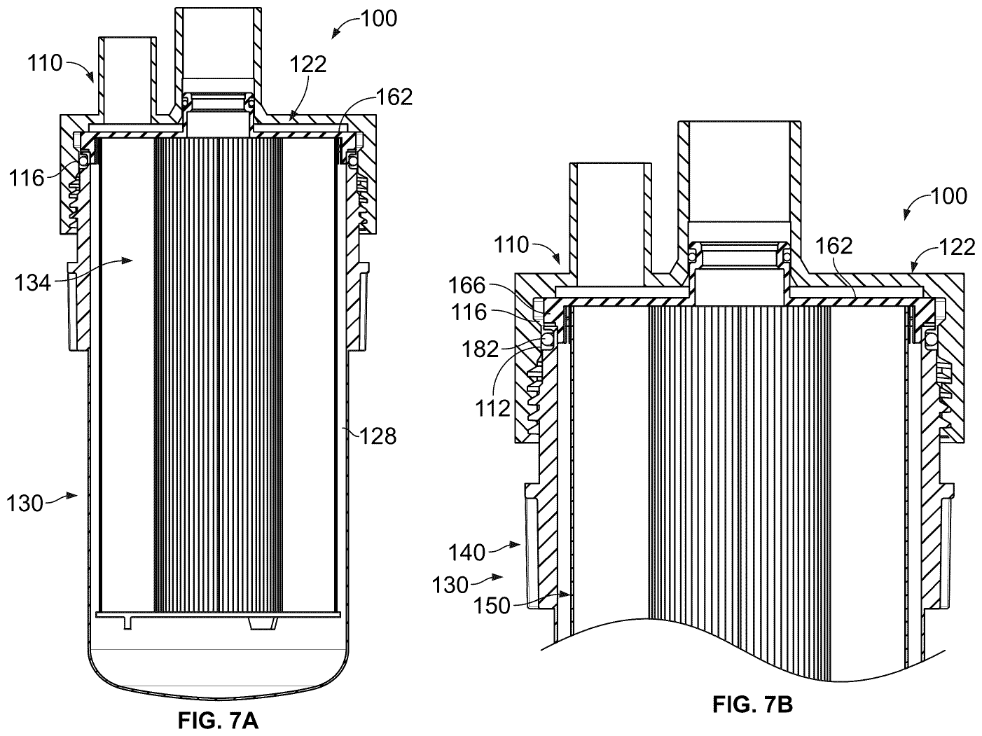

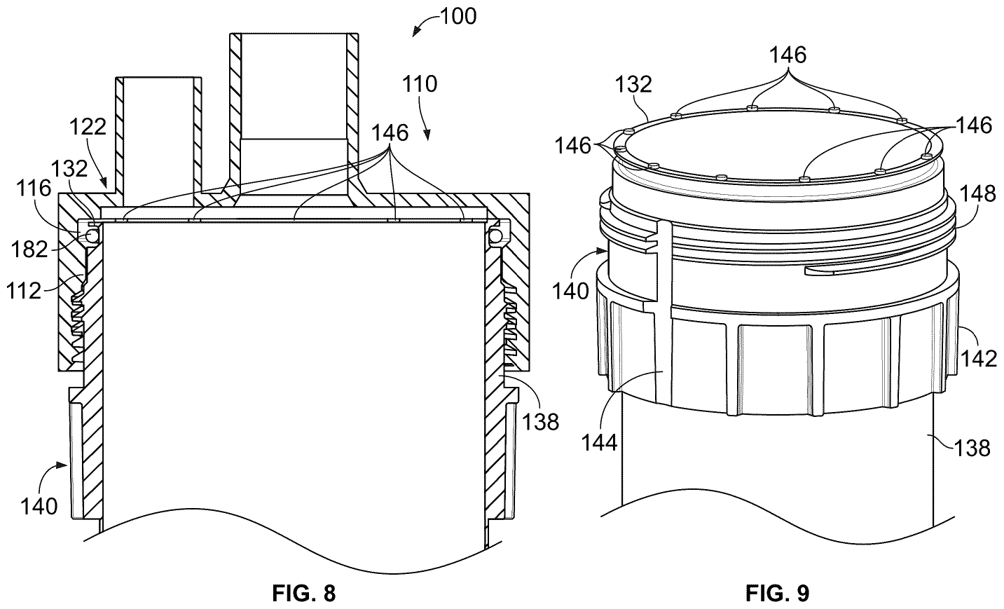

FIGS. 7A-9 show various views of a filter assembly 100 according to another example embodiment. As best shown in FIG. 8, the shell 138 includes one or more axial flanges 146 that extend axially away from the shell sealing channel 132. The axial flanges 146 are disposed around a perimeter of the shell 138. As best shown in FIG. 9, the shell 138 includes eleven (11) equally spaced axial flanges 146. However, it should be understood that the shell 138 may include more or fewer (e.g., at least one) axial flanges 146, and the axial flanges 146 may be spaced from each other at regular or irregular intervals. As shown in FIG. 7A and briefly described above, the shell wall 126 and the collar 140 are unitarily formed.

FIG. 7B is a detailed cross-sectional view of a portion of the filter assembly 100 of FIG. 7A, shown with a filter element 150 installed therein (within the shell 138). As described above with respect to FIG. 2A, the filter head 110 includes the first sealing surface 112 and the recessed wall 116. When the filter element 150 is installed in the filter assembly 100, the first sealing surface 112 forms the first circumferential, radially-directed seal with the first sealing member 182. When the filter cartridge 130 is installed, the first endplate 160 of the filter element 150 is positioned axially between the axial flanges 146 and the filter head wall 122 such that the first spacing members 166 are disposed between the axial flanges 146.

FIG. 8 is a detailed cross-sectional view of a portion of the filter assembly of FIG. 7A shown without a filter element 150. As briefly described above, the shell 138 includes the axial flanges 146 that extend axially away from the shell sealing channel 132. The axial flanges 146 contact the filter head wall 122 when the shell 138 is secured to the filter head 130 such that the axial flanges 146 space the shell 138 away from the filter head 110. More specifically, the axial flanges 146 space the shell sealing channel 132 away from the filter head wall 122 such that a fluid may flow therebetween. The axial flanges 146 are sized such that the first sealing member 182 is positioned within the recessed wall 116, as described above with respect to FIG. 2B. When the filter element 150 is not installed, the first circumferential seal is not formed, and the internal volume 134 is in fluid communication with the exterior of the filter assembly 100 via the collar axial channel 144.

FIG. 9 is a perspective view of a shell 138 of the filter assembly of FIG. 7A. The shell 138 includes the axial flanges 146 extending axially away from the shell sealing channel 132. The axial flanges 146 are disposed around a perimeter of the shell 132.

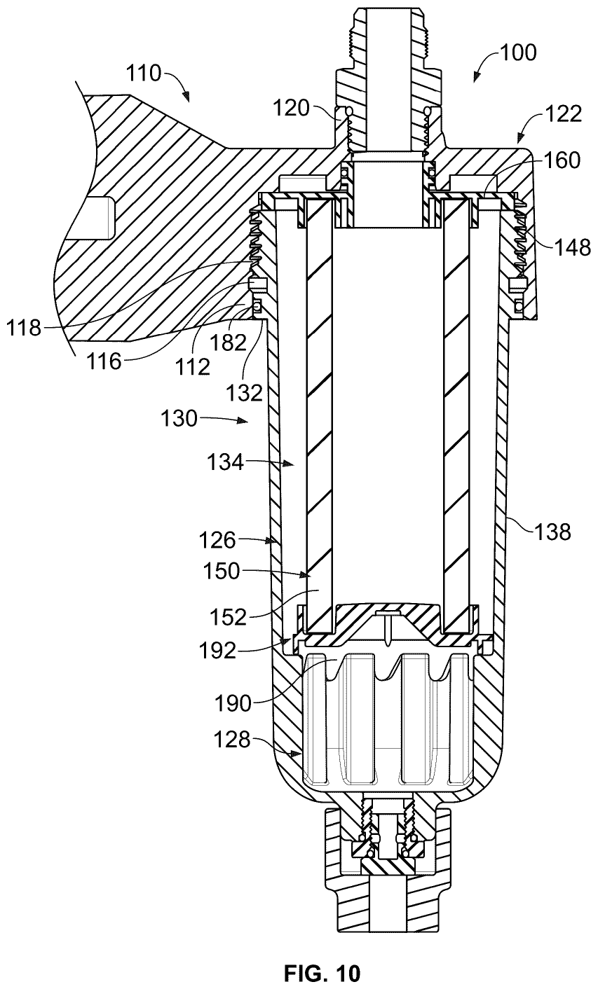

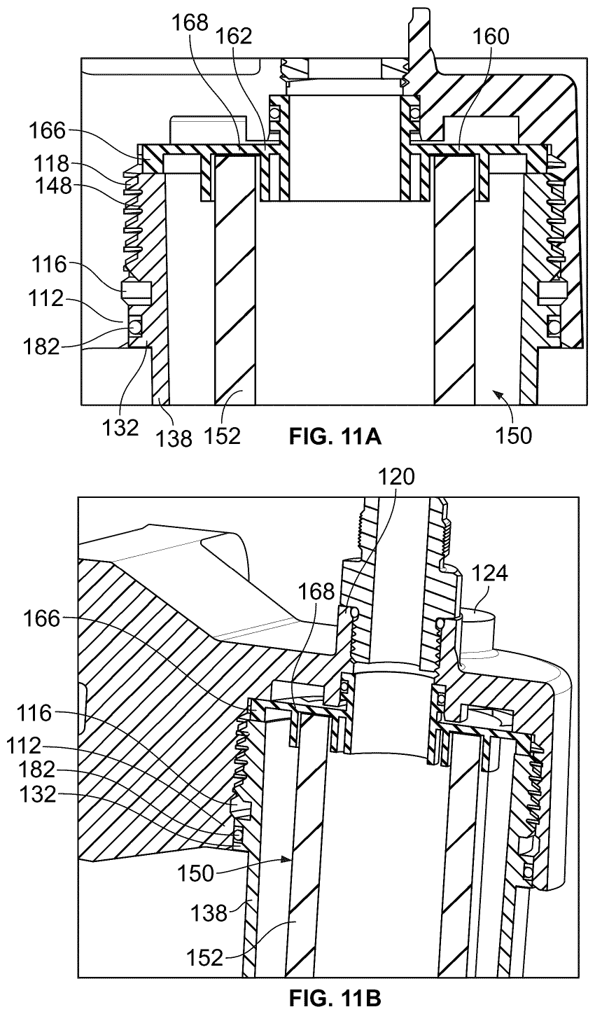

FIGS. 10-12 show various views of a filter assembly 100 according to another example embodiment. As best shown in FIG. 11A, first sealing surface 112 and the recessed wall 116 are positioned axially below the filter head threads 118. Similarly, the shell sealing channel 132 is positioned axially below the collar threads 148. The first sealing member 182 is advantageously positioned axially below the filter head threads 118 and the collar threads 148 (e.g., within the shell sealing channel 132. When the filter cartridge 130, having the filter element 150 installed within the shell 138, is threaded onto the filter head 110, the first sealing member 182 cannot contact the filter head threads 118. As shown in FIG. 10 and briefly described above, the shell wall 126 and the collar 140 are unitarily formed. Further, it should be understood that the axial flanges 146 of FIG. 8 may be utilized in the embodiments shown in FIGS. 10-12.

As shown in FIG. 10 the second endplate 190 may define a gap 192 between the second endplate and the shell 138. A fluid may drain out of the internal volume 134 and into a collection area shown as bowl 128. The bowl 128 may be unitarily formed with the shell 138 such that the shell wall 126 is continuous with the bowl 128.

Now referring to FIGS. 11A and 11B, a detailed cross-sectional view of a portion of the filter assembly 100 of FIG. 10 and a perspective cross-sectional view of a portion of the filter assembly 100 of FIG. 10 are shown, respectively. The filter head threads 118 engage with the collar threads 148 axially above the first sealing surface 112 and the shell sealing channel 132. When the filter cartridge 130 is installed, the first spacing member 166 spaces the shell 138 away from the filter head 110 such that the first sealing surface 112 is substantially aligned with the shell sealing channel 132 and the first sealing member 182 forms the first circumferential seal.

In the embodiment shown in FIGS. 11A and 11B, the first spacing member 166 has a first dimension that extends axially away from the endplate end wall 162. The first spacing member 166 extends in the first dimension a predetermined length away from the endplate end wall 162 such that the first spacing member 166 spaces a top portion of the shell 138 away from the filter head 100. More specifically, the first spacing member 166 spaces the shell sealing channel 132 away from the recessed wall 116 by the predetermined length.

In the embodiment shown in FIGS. 11A and 11B, the second spacing member 168 is a circumferential channel that extends axially way from the endplate end wall 162 towards the second endplate 190. The second spacing member 168 receives the filter media 152 within the circumferential channel such that the second spacing member 168 locates the filter media 152 at a center of the filter element 150.

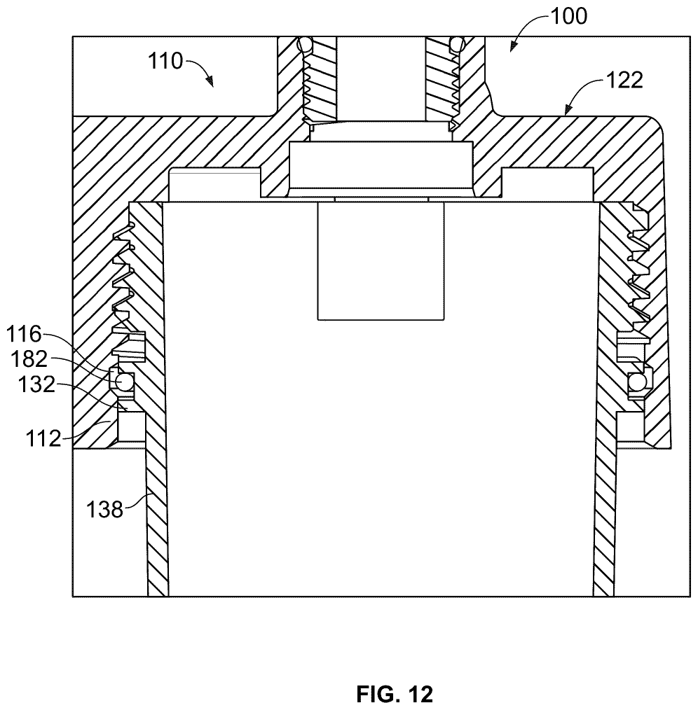

FIG. 12 is a detailed cross-sectional view of a portion of the filter assembly 100 of FIG. 10 without a filter element 150 installed therein. As described above with respect to FIG. 2B, when the first spacing member 166 is not present, the collar threads 148 engage with the filter head threads 118 until the first sealing member 182 is positioned within the recessed wall 116. The first sealing member 182 does not form a seal with the recessed wall 116 such that a fluid may flow between the shell 138 and the filter head 110. When the filter element 150 is not installed, the first circumferential seal is not formed, and the internal volume 134 is in fluid communication with the exterior of the filter assembly 100 (e.g., via the collar axial channel 144).

Various example embodiments provide for a method of installing a filter cartridge 130 within a filter assembly. The method includes positioning the filter cartridge 130 having a filter element installed within the shell 138 (as shown in FIG. 6) within the filter head 110. At least one of the plurality of first spacing members 166 limits the threading of the filter cartridge 130 onto the filter head 110 such that the first sealing member 182 contacts and forms a first circumferential seal with the first sealing surface 112 of the filter head 110.

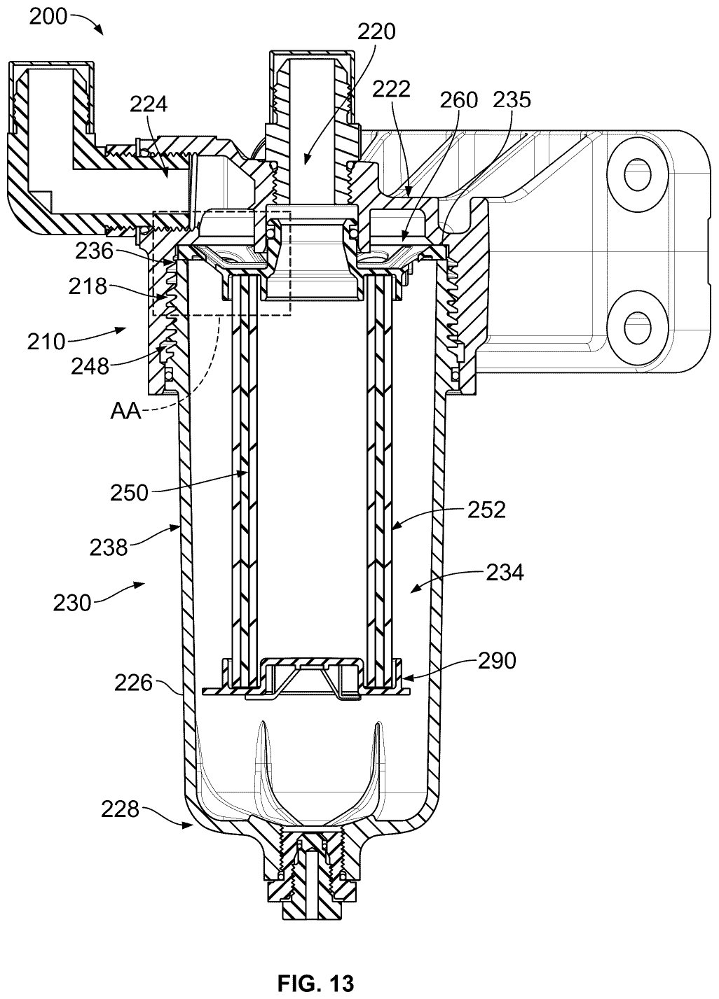

Referring now to FIG. 13, a cross-sectional view of a filter assembly 200 is shown, according to an example embodiment. The filter assembly 200 is similar to the filter assembly 100 shown in FIGS. 10-12. Accordingly, like numbering is used to denote like parts between the filter assembly 200 and the filter assembly 100.

The filter assembly 200 includes a filter head 210 and a filter cartridge 230 removably coupled to the filter head 210. It should be understood that the filter assembly 200 may include more or fewer components than as shown in FIG. 13. In some embodiments, the filter assembly 200 is a compressed gas filter assembly configured to filter a compressed gas, such as natural gas. In some embodiments, the filter assembly 200 is configured for filtering liquids, such as fuel, oil, water, and the like.

The filter head 210 includes a filter head wall 222. The filter head 210 includes a first port 220 and a second port 224. One of the first port 220 and the second port 224 is an inlet, and the other of the first port 220 and the second port 224 is an outlet. For example, in particular embodiments the first port 220 is an inlet for providing a dirty or unfiltered fuel to the filter assembly 200, and the second port 224 is an outlet for providing a filtered fuel to a downstream component such as an engine. The filter head 210 also includes one or more inward facing threads shown as filter head threads 218. The filter head threads 218 are configured to receive one or more outward facing threads, such as one or more outward facing treads shown as shell threads 248 of the filter cartridge 230.

The filter cartridge 230 includes a shell 238 and a filter element 250. The shell 238 includes a shell wall 226. The shell 238 defines an internal volume 234. In various embodiments, the filter element 250 is removably positioned within the shell 238. The shell 238 is structured to receive the filter element 250 at least partially within the internal volume 234.

The filter element 250 includes a filter media 252 fitted between a first endplate 260 (e.g., upper endplate, top endplate, etc.) and a second endplate 290 (e.g., lower endplate, bottom endplate, etc.). For example, the first endplate 260 is coupled to the filter media 252 at a filter media first end, and the second endplate 290 is coupled to the filter media 252 at a filter media second end, opposite the first end. The filter media 252 may include one or more media layers such as a pleated and/or woven filter media, a hydrophobic screen, and/or any other suitable filter media layer.

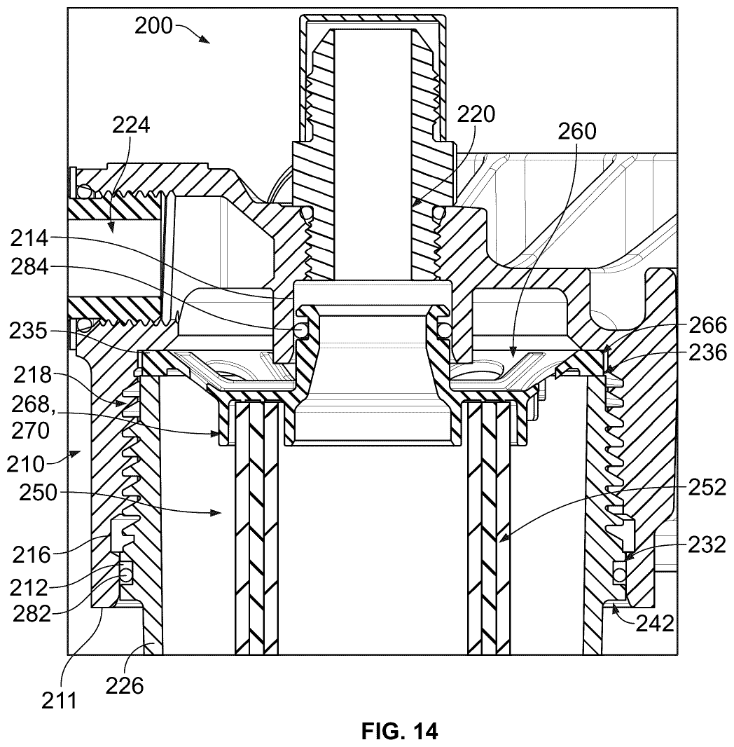

Turning now to FIG. 14, a detailed cross-sectional view of a portion of the filter assembly 200 is shown with the filter element 250 installed (e.g., positioned within the shell 238). The filter head 210 includes a first sealing surface 212, a second sealing surface 214, a recessed wall 216, and the filter head threads 218. The filter head 210 also includes the first port 220 and the second port 224. The first sealing surface 212 is structured to (e.g., configured to) form a first radial sealing engagement (e.g., a first seal) with the filter cartridge 230. Specifically, the first sealing surface 212 is configured to form a first sealing engagement with a first sealing member 282 coupled to the shell 238. The first sealing member 282 may be one of an O-ring, a gasket, an over molded polymeric components, and the like. The second sealing surface 214 is similar to the first sealing surface 212 and is structured to form a second circumferential, sealing engagement (e.g., a second seal) with the filter cartridge 230. Specifically, the second sealing surface 214 is configured to form a second sealing engagement with a second sealing member 284 coupled to the first endplate 260. A circumference of the first sealing surface 212 is greater than a circumference of the second sealing surface 214. The second sealing member 284 may be one of an O-ring, a gasket, an over molded polymeric components, and the like.

The recessed wall 216 is a portion of a side wall of the filter head 210 that is positioned proximate to the first end 211 of the filter head 210, the first end 211 defining an opening configured to receive the shell threads 248. The recessed wall 216 is interposed (e.g., positioned) between the filter head threads 218 and the first end 211. The recessed wall 216 is farther away from the filter element 250 (when installed) than the portion of the filter head defined by the first sealing surface 212. In other words, a circumference of the recessed wall 216 is greater than a circumference of the first sealing surface 212. In other words, the recessed wall 216 is positioned radially outward from the first sealing surface 212. In the embodiment shown in FIG. 14, both the first sealing surface 212 and the recessed wall 216 are positioned between the filter head threads 118 and the first end 211 of the filter head 210. Further, the recessed wall 216 is positioned between (e.g., axially between) the first sealing surface 212 and the filter head threads 218. The first sealing surface 212 is positioned between the recessed wall 216 and the first end 211. In some embodiments, the first sealing surface 212 is contiguous with the first end 211 and defines an opening of the filter head 210.

The shell 238 includes a shell sealing channel 232 configured to receive the first sealing member 282 therein. When the shell 238 is coupled to the filter head 210, the first sealing member 282 cooperates with the first sealing surface 212 to form a first radial sealing engagement (e.g., a first seal) between the shell 238 and the filter head 210. The first radial seal provides a substantially watertight seal and substantially prevents a fluid from flowing between the shell 238 and the filter head 210.

The shell sealing channel 232 is positioned between the shell threads 248 and the second end 228 of the shell 238. The shell threads 248 are interposed (e.g., positioned) between the first shell end 236 of the shell 238 and the shell sealing channel 232. In some embodiments, the shell sealing channel 232 extends radially into a shell flange 242 that extends radially away from the shell 238. In some embodiments, the shell flange 242 includes a diameter that is greater than a diameter of the shell threads 248. In some embodiments, a diameter of the shell flange 242 is generally equal to, though slightly smaller than, a diameter of the first sealing surface 212 such that a slip fit is formed between the shell flange 242 and the first sealing surface 212.

When the filter cartridge 230 is coupled to the filter head 210, the filter head threads 218 engage with the shell threads 248. A first spacing member 266 of the first endplate 260 is positioned between the first shell end 236 of the shell 238 and the end surface 235 of the filter head 210. In other words, a diameter of the first endplate 260 is greater than a diameter of the inner surface of the shell 238 proximate to the first shell end 236 such that a portion of the first endplate 260, shown as the first spacing member 266, is interposed between the end surface of the filter head 210 and the first shell end 236 when the filter cartridge 230 is properly installed within the filter head 210. An axial height of the first spacing member 266 is structured to position the first sealing member 282 in a sealing engagement with the first sealing surface 212 when the filter cartridge 230 is coupled to the filter head 210. In other words, the first spacing member 266 spaces the shell sealing channel 232 away from the end surface 235 of the filter head 210 by a distance equal to the distance between the end surface 235 and the first sealing surface 212.

Extending axially away from the first endplate 260 is a media channel 268 configured to receive the filter media 252. The media channel 268 is defined by a pair of annular walls 270 that extend axially from the first endplate 260 at a position radially inward from the first spacing member 266, and at a position radially outward from a center axis of the filter cartridge 230. The annular walls 270 extend axially in a direction toward the second endplate 290.

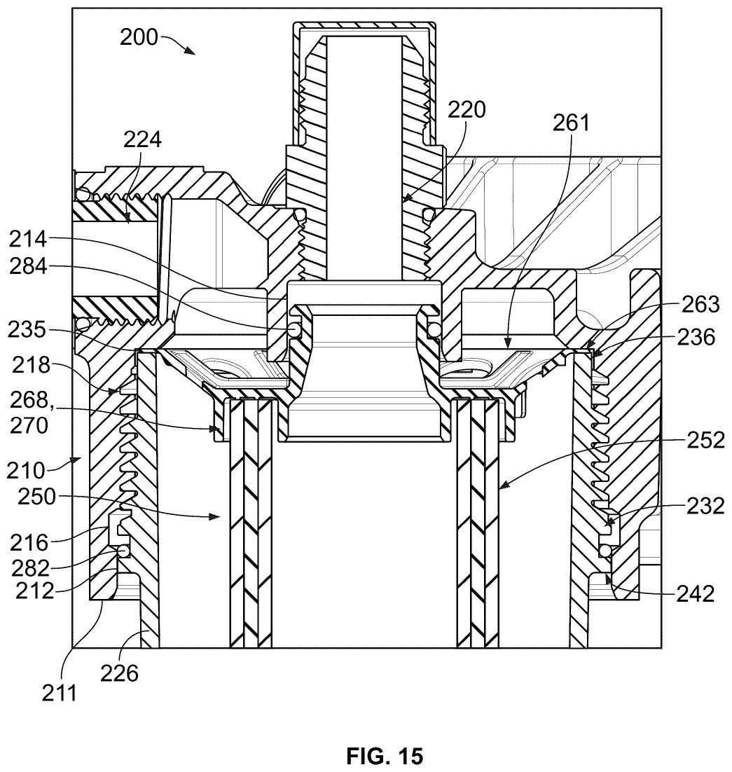

Referring now to FIG. 15, a detailed cross-sectional view of a portion of the filter assembly 200 including an alternative filter element is shown. The alternative filter element is similar to the filter element 250 and includes an alternative endplate 261 that is similar to the first endplate 260. Accordingly, like numbering is used to denote like parts between the alternative filter element and the filter element 250. A difference between the alternative endplate 261 and the first endplate 260 is that an alternative spacing member 263 of the alternative endplate 261 has an axial height that is less than the axial height of the first spacing member 266. Because the axial height of the alternative spacing member 263 is less than the axial height of the first spacing member 266, the distance between the shell sealing channel 232 and the end surface 235 is less than the distance between the first sealing surface 212 and the end surface 235. Accordingly, when the alternative filter cartridge with the alternative endplate 261 is coupled to the filter head 210, the shell sealing channel 232 is aligned with the recessed wall 216 and the first scaling member 282 does not form (e.g., is prevented from forming) a sealing engagement with the first sealing surface 212.

In some embodiments, when the spacing member of the endplate (e.g., the alternative spacing member 263 of the alternative endplate 261) is not present, the shell threads 248 engage with the filter head threads 218 until the first sealing member 282 is positioned within the recessed wall 216. In the aforementioned configuration, the first sealing member 282 does not form a seal with the recessed wall 216 such that a fluid may flow between the shell 238 and the filter head 210. When the filter element 250 is not installed, the first radial seal is not formed, and the internal volume 234 is in fluid communication with the exterior of the filter assembly 200.

Turning to FIGS. 16-18, the first endplate 260 of the filter element 250 of FIGS. 13 and 14 is shown. Referring specifically to FIG. 16, a perspective view of the first endplate 260 is shown. The first endplate 260 includes the first spacing member 266 extending circumferentially about the outermost circumference of the first endplate 260. The first spacing member 266 includes a first engagement surface 302 that lies in a first endplate plane. The first engagement surface 302 is configured to engage the end surface 235 of the filter head 210 when the filter cartridge 230 is installed. Extending radially from the first spacing member 266 is a sloped wall 304 (e.g., sloped flange, frustoconical flange, etc.). The sloped wall 304 extends radially inward from the first spacing member 266 and toward the central axis of the first endplate 260. The sloped wall 304 defines a substantially frustoconical shape that tappers to a smaller diameter as the sloped wall 304 extends further from the first spacing member 266. As shown in FIG. 18, the sloped wall 304 extends at a first angle α of between 30-60°, inclusive, relative to the central axis of the first endplate 260. In some embodiments, the sloped wall 304 extends at an angle of between 45-55°, inclusive, relative to the central axis of the first endplate 260.

A plurality of wall apertures 306 extend through the sloped wall 304. Each of the wall apertures 306 extends perpendicularly through the sloped wall 304 such that a central axis of each of the wall apertures 306 extends at a right angle relative to the sloped wall 304 and intersects the central axis of the second endplate 290. In some embodiments, each of the wall aperture 306 extends parallel to the central axis of the first endplate 260. As shown, the plurality of apertures 306 includes eight (8) apertures. While eight wall apertures are shown, it should be understood that the sloped wall 304 may include more or fewer apertures positioned either regularly or irregularly about the circumference of the sloped wall 304.

The incline of the sloped wall 304 and the position and orientation of the plurality of apertures 306 cooperate to divert a flow of fluid to flow toward the central axis of the filter cartridge 230. The inwardly angled direction of flow through the plurality of apertures 306 leads to reduced wall shear stresses and, therefore, reduced oil carryover, which is particularly important for systems using gaseous fluids.

The first endplate 260 further includes an annular flange extending radially inward from an underside of the first spacing member 266, shown as a step 318 (FIG. 18). The step 318 defines a diameter that is less than a diameter of the inner surface of the shell 238. The step 318 assists in breaking (e.g., interrupting, disturbing, etc.) the oil film on the shell inner wall and thus reduces oil carryover.

Each of the wall apertures 306 is substantially circular and defined by an annular aperture wall 310. The aperture wall 310 is separated from first spacing member 266 by a portion of the sloped wall 304, shown as an aperture spacer 312. The aperture spacer 312 positions the most radially outward portion of the aperture wall 310 (relative to the central axis of the first endplate 260) away from the first engagement surface 302, and the aperture spacer 312 is interposed between the aperture wall 310 and the first spacing member 266. The most radially-inward portion of the aperture wall 310 (relative to the central axis of the first endplate 260) is positioned at an inner circumference 314 of the sloped wall 304, where the sloped wall 304 meets the endplate end wall 262. Accordingly, the aperture wall 310 is positioned entirely within the inner circumference 314 of the sloped wall 304 and an outer circumference 315 of the sloped wall 304. In some embodiments, the aperture wall 310 is a non-circular shape, such as an oval, pill, obround, ellipse, and the like. The aperture wall 310 is spaced apart from the center pipe 316 by the endplate end wall 262.

Interposed between each of the plurality of apertures 306, and extending radially across the sloped wall 304 is a plurality of buttresses 320 (e.g., flanges, support members, etc.). Each of the plurality of buttresses 320 extends axially from the endplate end wall 262.

Extending radially from an inner circumference 314 of the sloped wall 304 is the endplate end wall 262. The endplate end wall 262 lies in a plane substantially parallel to the first endplate plane. Extending axially from the endplate end wall 262 is a center pipe 316. When the filter cartridge 230 is coupled to the filter head 210, the center pipe 316 is in fluid communication with the first port 220 such that a flow of fluid may be received within the filter cartridge 230 from the filter head 210. The center pipe 316 includes the endplate scaling channel 274 configured to receive the second sealing member 284, the second sealing member 284 configured to form a sealing engagement with the second sealing surface 214 when the filter cartridge 230 is coupled to the filter head 210.

Referring now to FIG. 17, a perspective bottom view of the first endplate 260 is shown. The first endplate 260 further includes a first alignment tab 330 and a second alignment tab 332 positioned radially opposite the first alignment tab 330 (e.g., positioned approximately 180° rotational degrees from the first alignment tab 330). The first alignment tab 330 and the second alignment tab 332 extend axially away from the first spacing member 266 in a direction opposite to the center pipe 316 and in the same direction as the walls 270 defining the media channel 268. The first alignment tab 330 and the second alignment tab 332 are configured to engage the shell 238 and prevent rotation of the first endplate 260 relative to the shell 238. While only two alignment tabs are shown, it should be understood that any number of alignment tabs may be provided with the first endplate 260.

Referring now to FIGS. 19-21, the first endplate 260 of the filter cartridge 230 of FIGS. 13 and 14 is shown, according to an example embodiment. The first endplate 260 is shown as including six wall apertures 306 positioned asymmetrically (e.g., irregularly) about the circumference of the sloped wall 304. The first endplate 260 includes a solid endplate portion 340 where the sloped wall 304 is solid and does not include any of the plurality of apertures 306. As shown, the solid endplate portion 340 is a 90° sector (e.g., quadrant) of the first endplate 260. In some embodiments, the solid endplate portion 340 includes a larger sector (e.g., 110°, 130°, 150°, etc.) of the first endplate 260. In some embodiments, the first endplate portion includes a smaller sector (e.g., 45°, 30°, etc.) of the first endplate 260.

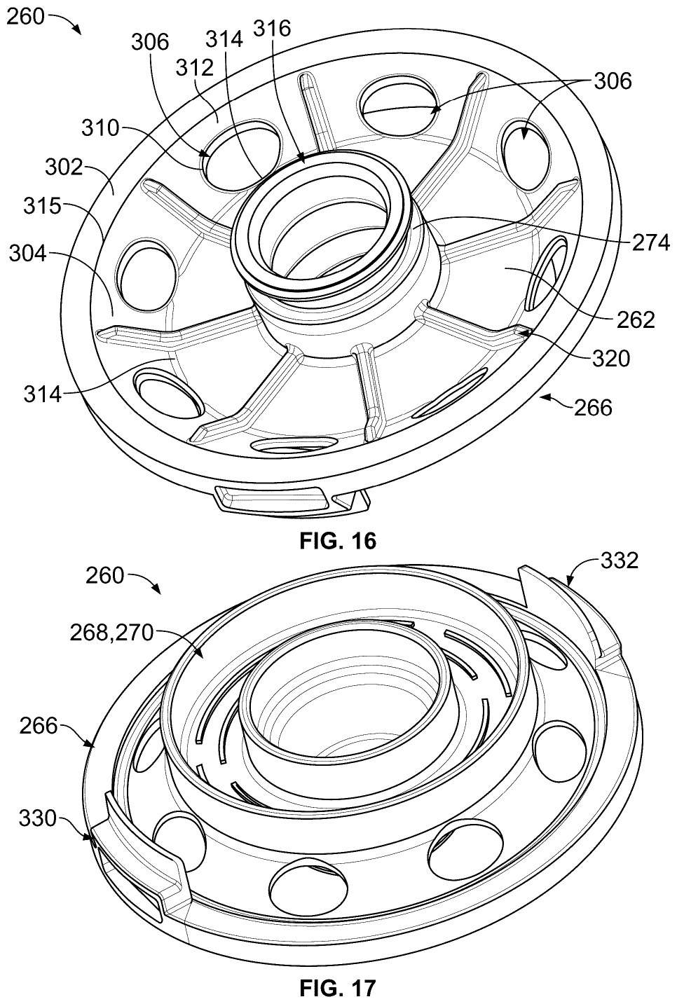

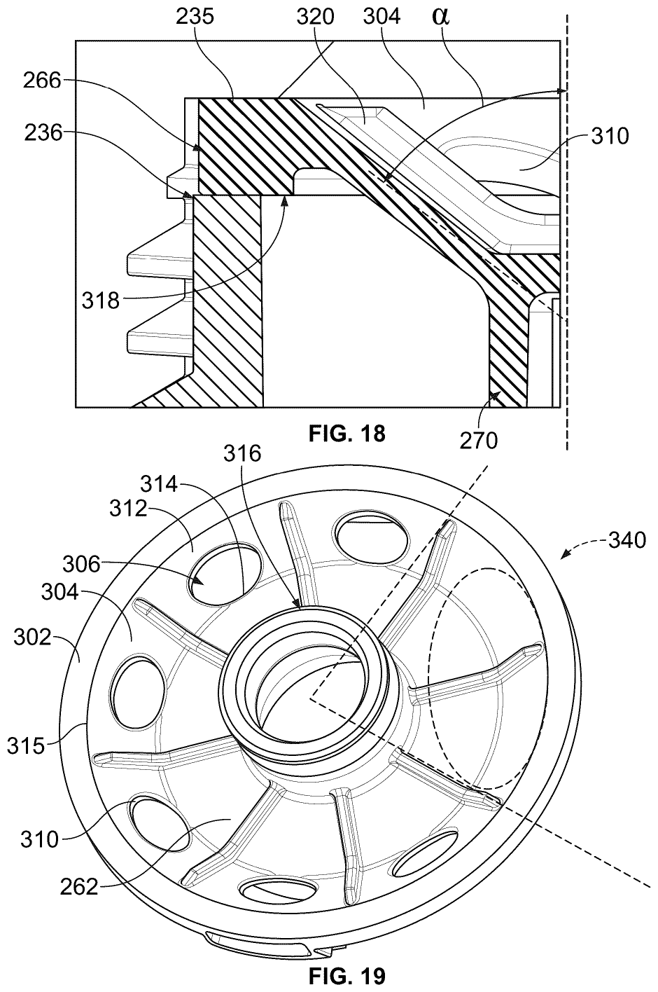

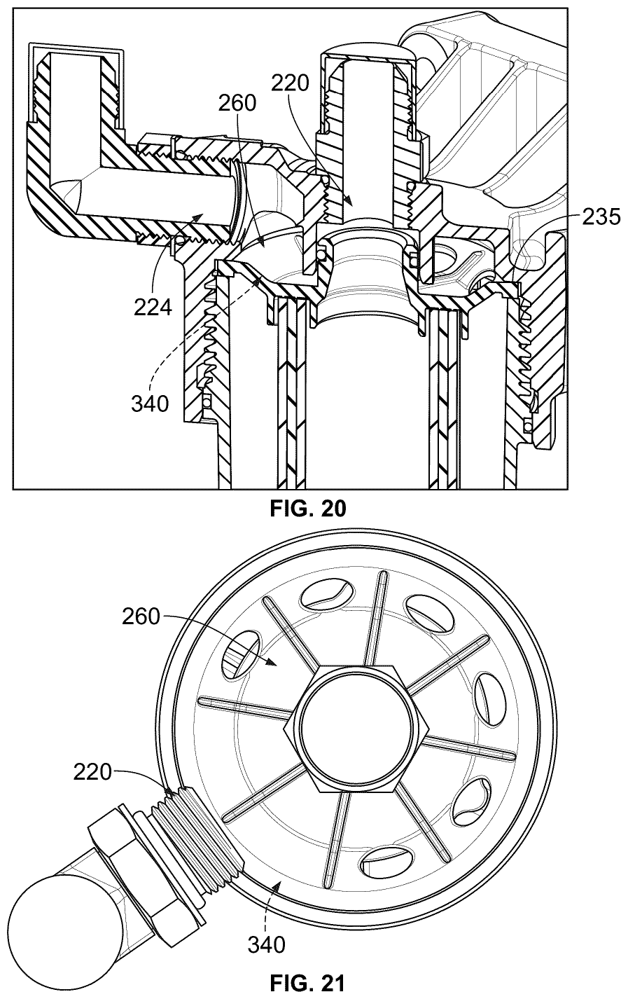

As shown in FIGS. 20 and 21, when the first endplate 260 is coupled to the shell 238 and the filter cartridge 230 is coupled to the filter head 210, the solid endplate portion 340 is aligned with (e.g., positioned to face) the first port 220. When the first endplate 260 is positioned such that the solid endplate portion 340 is aligned with the first port 220, exit flow will be directed away from the first port 220 and will be distributed around the first endplate 260. This arrangement will prevent mass velocity from gathering below the first port 220. This arrangement will also reduce the chances of oil carryover.

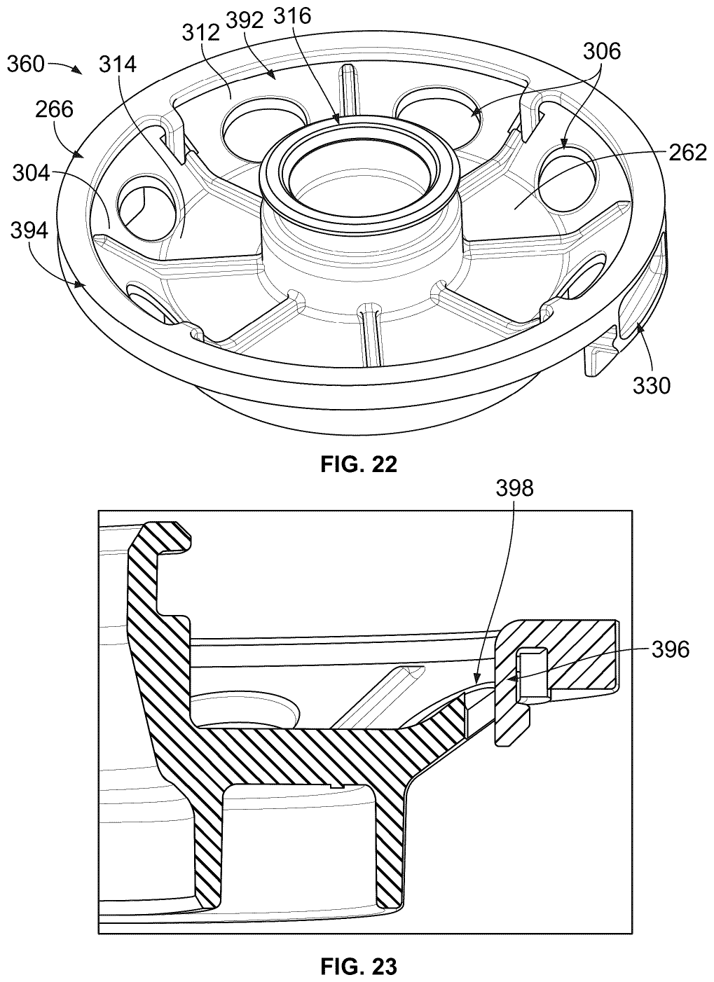

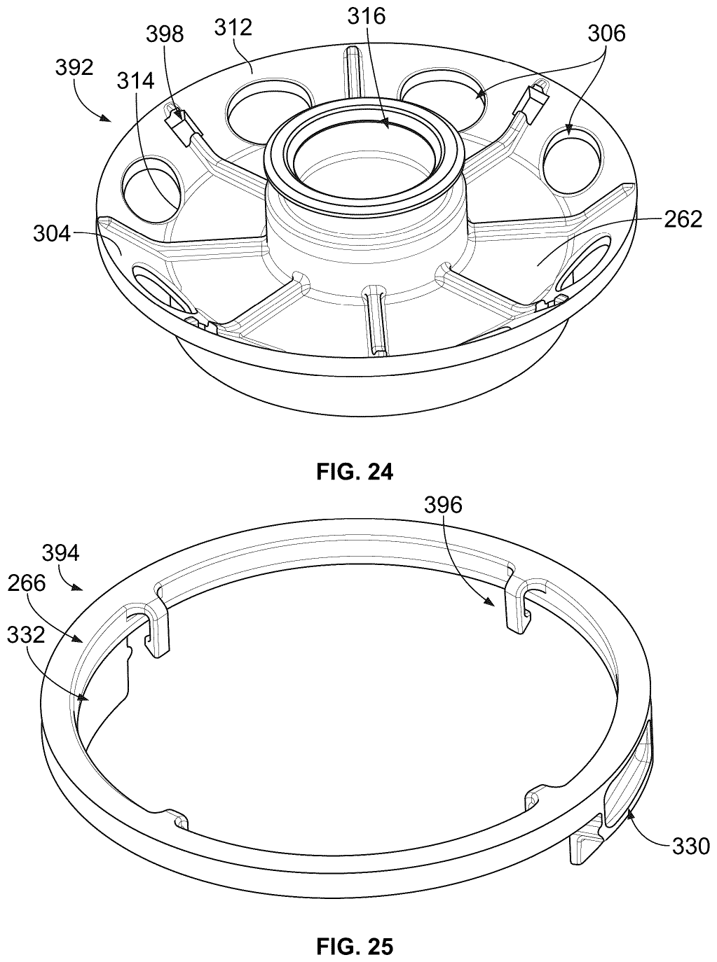

Referring now to FIGS. 22-25, an alternative first endplate 360 (e.g., upper endplate 360) usable with the filter element 250 of FIGS. 13-15 is shown, according to an example embodiment. The first endplate 360 is similar to the first endplate 260 shown in FIGS. 13-21. Accordingly, like numbering is used to denote like parts between the first endplate 260 and the first endplate 360. A difference between the first endplate 260 and the alternative first endplate 360 is that the first spacing member 266 is removably coupled to the first endplate 360. More specifically, the first endplate 360 includes an endplate body portion 392 and a spacing portion 394 removably coupled to the endplate body portion 392. The spacing portion 394 includes the first spacing member 266, the first alignment tab 330, and the second alignment tab 332. As shown in FIG. 23, the spacing portion 394 further includes a plurality of latches 396 configured to extend through and couple to the endplate body portion 392. The plurality of latches 396 are configured to flex radially inward toward the central axis of the first endplate 360 when the spacing portion 394 is coupled to and decoupled from the endplate body portion 392. The endplate body portion 392 includes a plurality of coupling apertures 398 that extend axially through the endplate body portion 392 in a direction substantially parallel to the central axis of the first endplate 360. The spacing portion 394 is coupled to the endplate body portion 392 by moving the spacing portion 394 axially toward the endplate body portion 392 such that the plurality of latches 396 extend through the plurality of coupling apertures 398.

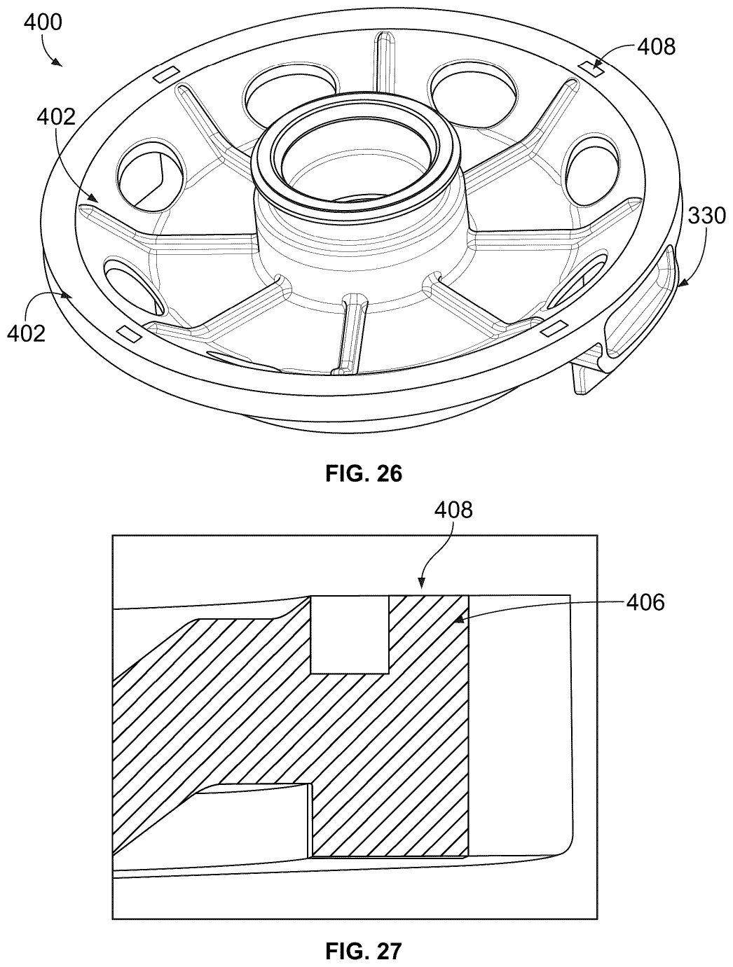

Referring now to FIGS. 26-29, an alternative first endplate 400 (e.g., upper endplate 400) usable with the filter element 250 of FIGS. 13-15 is shown, according to an example embodiment. The first endplate 400 is similar to the first endplate 360 shown in FIGS. 22-25. Accordingly, like numbering is used to denote like parts between the first endplate 400 and the first endplate 360. A difference between the first endplate 400 and the first endplate 360 is that the spacing portion 404 of the first endplate 400 includes a plurality of apertures 408 that extend axially through the spacing portion 404 in a direction substantially parallel to the central axis of the first endplate 400.

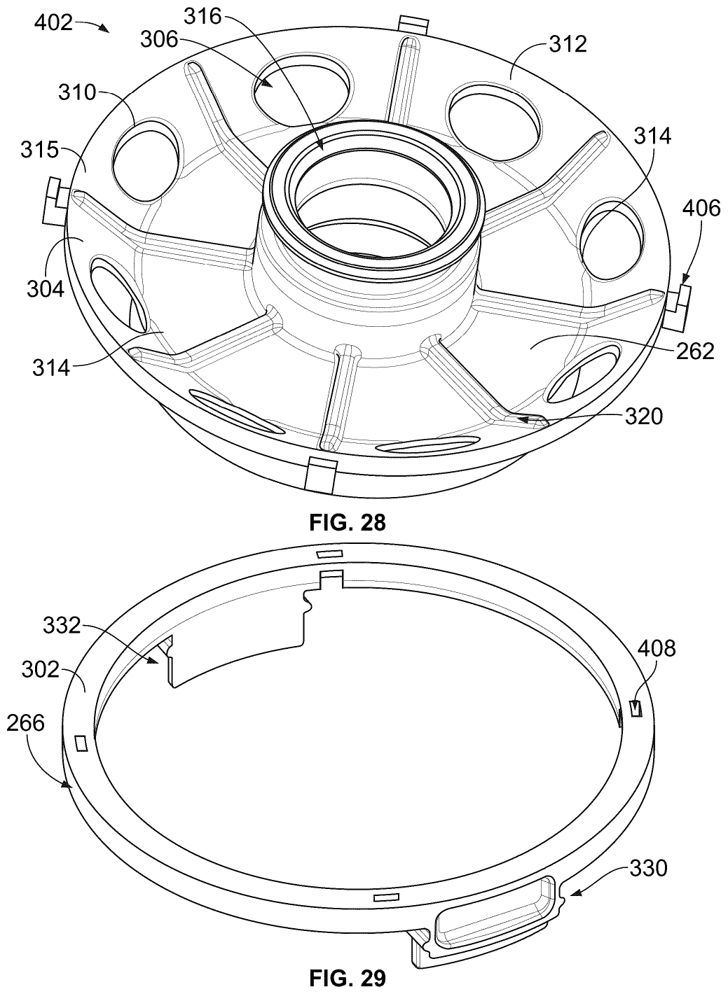

The first endplate 400 includes an endplate body portion 402 and a spacing portion 404 removably coupled to the endplate body portion 402. The spacing portion 404 includes the first spacing member 266, the first alignment tab 330, and the second alignment tab 332. As shown in FIG. 28, the endplate body portion 402 further includes a plurality of L-shaped posts 406 extending from an outermost circumference of the endplate body portion 402. The plurality of L-shaped posts 406 include a portion that extends radially outward from the outer circumference of the endplate body portion 402, and the plurality of L-shaped posts 406 includes a portion that extends axially in a direction substantially parallel to the central axis of the first endplate 400, and extending axially in a direction similar to the direction the center pipe 316 extends. The spacing portion 404 is coupled to the endplate body portion 402 by moving the spacing portion 404 axially toward the endplate body portion 402 such that the plurality of posts 406 extend through the plurality of apertures 408.

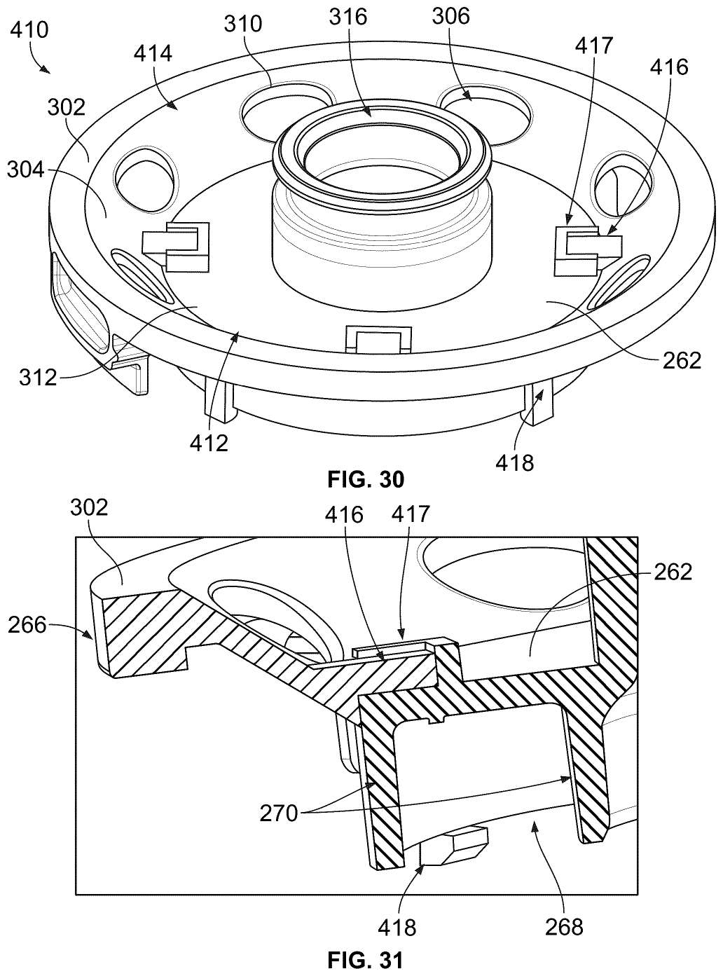

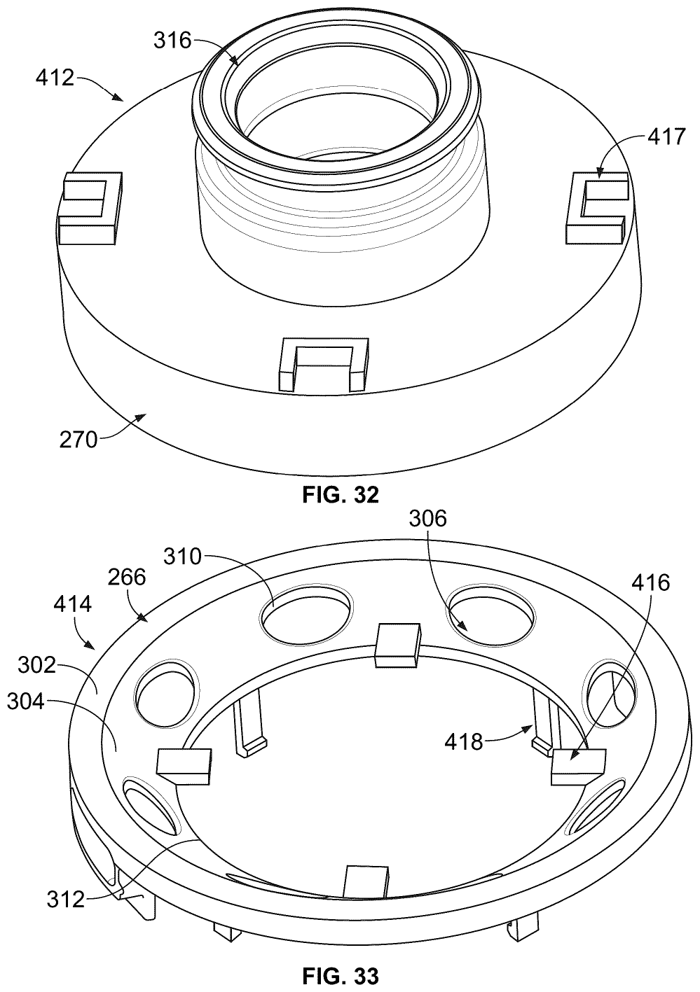

Referring now to FIGS. 30-33, an alternative first endplate 410 (e.g., upper endplate 410) usable with the filter cartridge 230 of FIGS. 13-15 is shown, according to an example embodiment. The first endplate 410 is similar to the first endplate 360 shown in FIGS. 22-25. Accordingly, like numbering is used to denote like parts between the first endplate 410 and the first endplate 360. A difference between the first endplate 410 and the first endplate 360 is that the spacing portion 414 of the first endplate 410 includes the sloped wall 304.

The first endplate 410 includes an endplate body portion 412 and a spacing portion 414 removably coupled to the endplate body portion 412. The spacing portion 414 includes the first spacing member 266, the first alignment tab 330, the second alignment tab 332, and the sloped wall 304. The first endplate 410 further incudes a plurality of projections 416 extending radially inward from an inner circumference of the sloped wall 304, the plurality of projections 416 configured to engage a slot 417 (e.g., coupling member) of the endplate body portion 412. The spacing portion 414 further includes a plurality of latches 418 that extend axially away from the spacing portion 414 proximate to the inner circumference of the sloped wall 304, the plurality of latches 418 extending in a direction substantially parallel to the central axis of the first endplate 410 and the plurality of latches 418 extending in a direction similar to the first alignment tab 330 and the second alignment tab 332.

The slots 417 are positioned on the 262 of the endplate body portion 412 and are positioned proximate to an outer circumference of the 262. The slots 417 define a U-shape where the top of the U (e.g., the opening of the slots 417) fac es in a radial direction away from the center pipe 316. The spacing portion 414 is coupled to the endplate body portion 412 by moving the spacing portion 414 axially toward the endplate body portion 412 such that the plurality of projections 416 are positioned within the plurality of slots 417, and such that the plurality of latches 418 engage the walls that define the media channel 268.

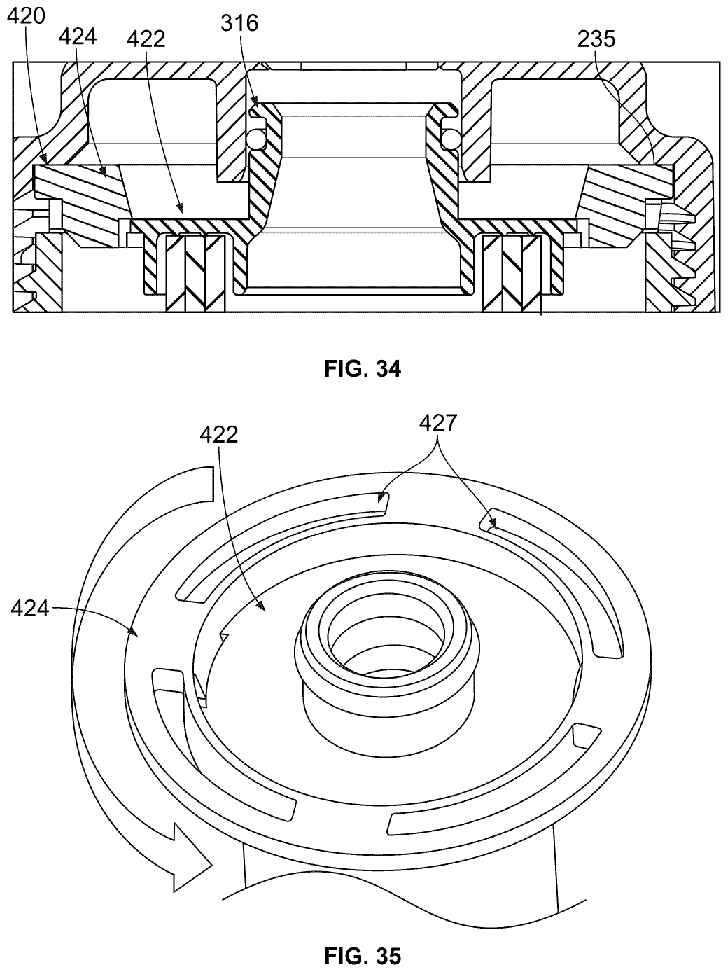

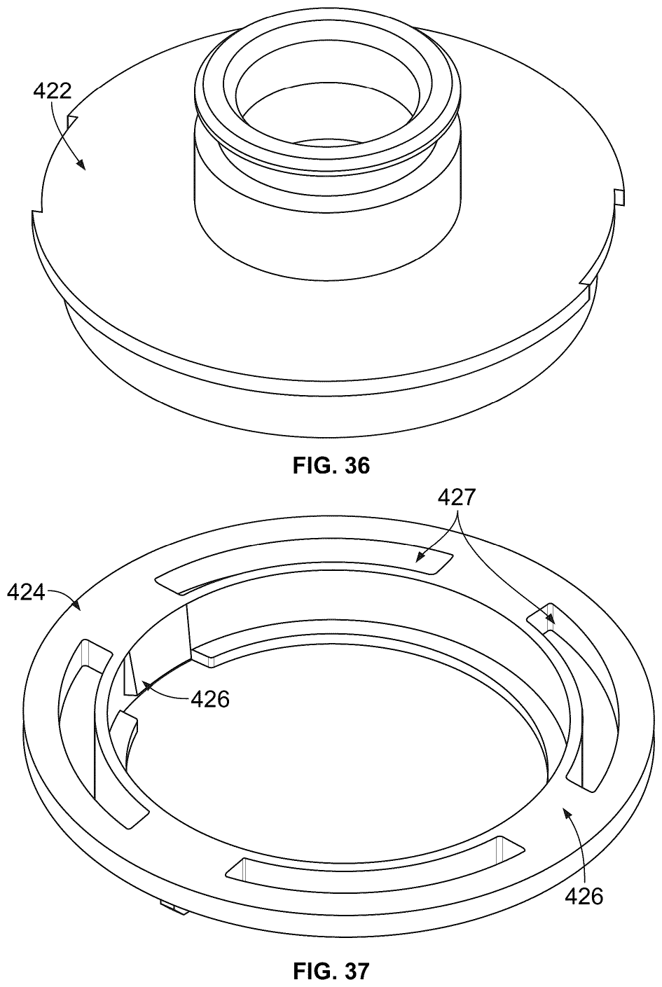

Referring now to FIGS. 34-37, an alternative first endplate 420 (e.g., upper endplate 420) usable with the filter cartridge 230 of FIGS. 13-15 is shown, according to an example embodiment. The first endplate 420 is similar to the first endplate 360 shown in FIGS. 22-25. Accordingly, like numbering is used to denote like parts between the first endplate 420 and the first endplate 360. A difference between the first endplate 420 and the first endplate 360 is that the spacing portion 424 of the first endplate 420 is rotatable relative to the endplate body portion 422 when the spacing portion 424 is coupled to the endplate body portion 422.

The first endplate 420 includes an endplate body portion 422 and a spacing portion 424 removably coupled to the endplate body portion 422. The spacing portion 424 includes the first spacing member 266, a pair of clips 426 (FIG. 37), and a plurality of apertures 427. The pair of clips 426 is configured to snap onto the endplate body portion 422 to couple the spacing portion 424 to the endplate body portion 422. The first endplate 420 is structured such that when the first endplate 420 is coupled to the shell 238 and the filter cartridge 230 is coupled to the filter head 210, the endplate body portion 422 is rotatable relative to the spacing portion 424.

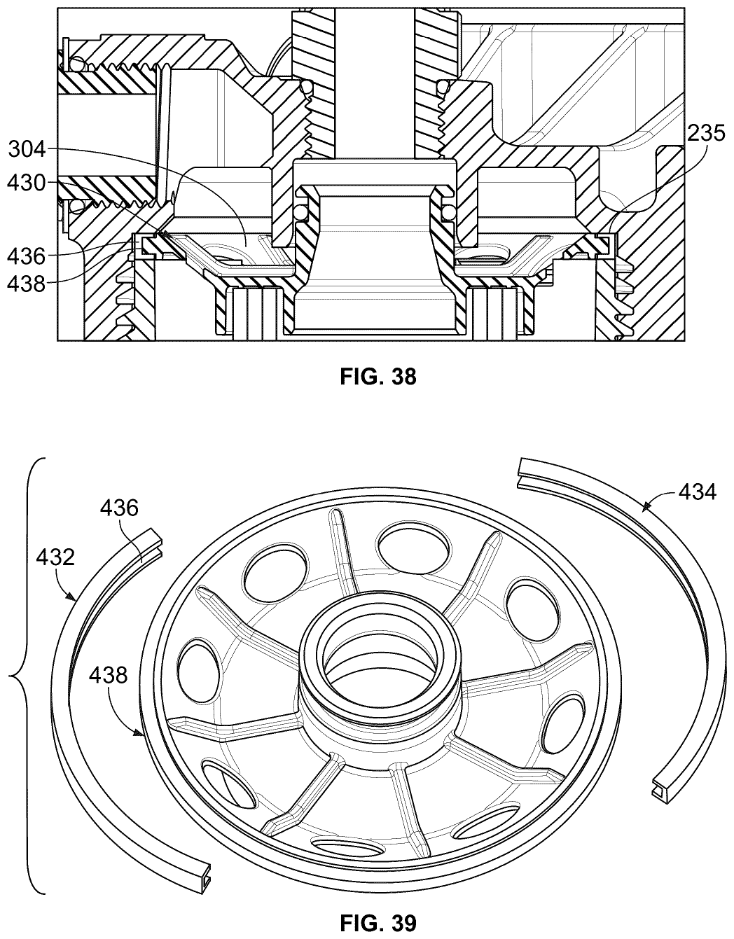

Referring now to FIGS. 38 and 39, an alternative first endplate 430 (e.g., upper endplate 430) usable with the filter cartridge 230 of FIGS. 13-15 is shown, according to an example embodiment. The first endplate 430 is similar to the first endplate 260. Accordingly, like numbering is used to denote like parts between the first endplate 430 and the first endplate 260. A difference between the first endplate 430 and the first endplate 260 is that the first spacing member 266 is separable from the first endplate 430. As shown in FIG. 39, the first spacing member 266 is formed of a first member portion 432 and a second member portion 434, each of the first member portion 432 and the second member portion 434 having a member channel 436 configured to receive a portion of the first endplate 430 that extends radially from an outer circumference of the first endplate 430, shown as a member flange 438. The first member portion 432 and the second member portion 434 are friction fit to the member flange 438 to removably couple the first spacing member 266 to the first endplate 430.

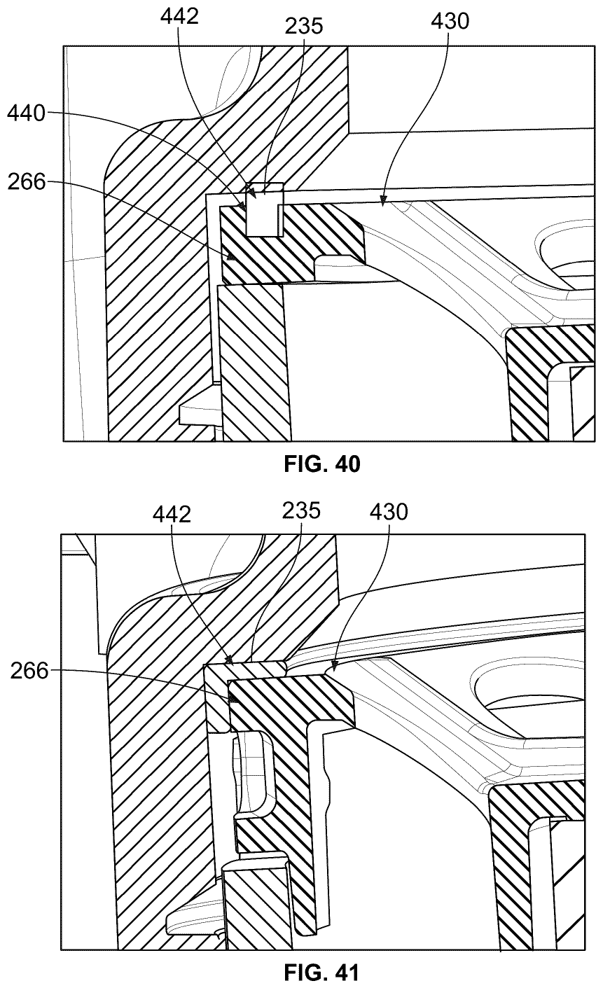

Referring now to FIGS. 40-43, detailed cross-section views of the filter assembly 200 of FIG. 13 are shown at view window AA, the filter assembly 200 being shown with the alternative first endplate 430 of FIG. 39 according to example configurations. Referring specifically to FIG. 40, the first endplate 430 includes a sealing channel 440 that extends axially into the first spacing member 266. The sealing channel 440 is structured to receive an additional spacing member, such as the second spacing member 442 shown. In some embodiments, the second spacing member 442 is a gasket configured to form a sealing engagement between the sealing channel 440 and the end surface 235. In some embodiments, the second spacing member 442 is formed of rigid, inelastic material that is unable to form a sealing engagement between the first endplate 430 and the filter head 210.

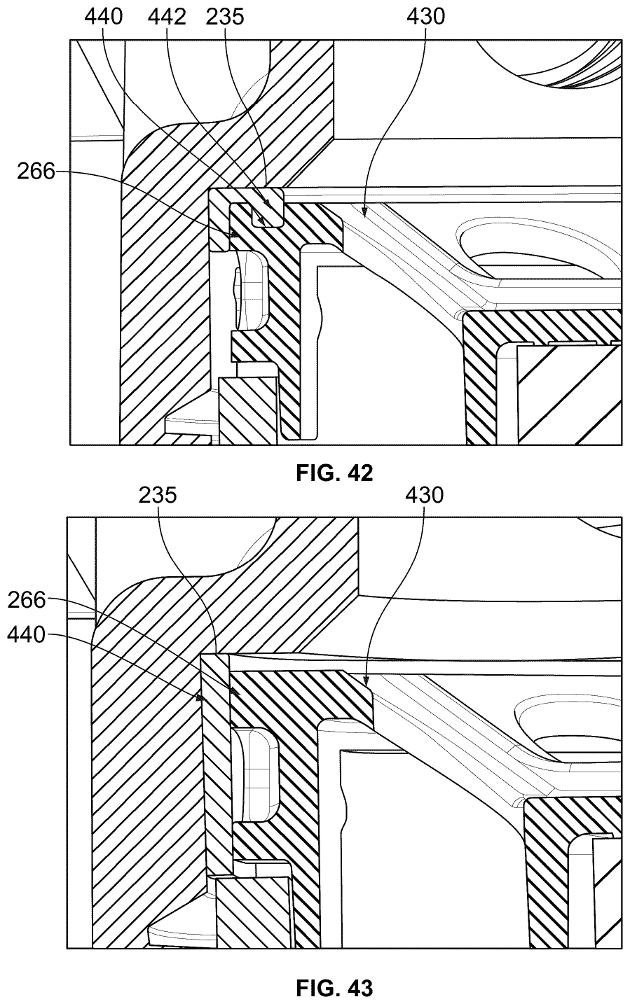

Referring specifically to FIG. 41, the second spacing member 442 has an L-shaped profile and is configured to fit snuggly between the first endplate 430 and the filter head 210. Referring specifically to FIG. 42, the second spacing member 442 defines a U-shaped profile and is configured to be positioned, at least partially, within the sealing channel 440. The second spacing member 442 further extends radially from the sealing channel 440. Referring now to FIG. 43, the second spacing member 442 is positioned circumferentially about the first spacing member 266 and is configured to engage both the shell 238 and the end surface 235 when the filter cartridge 230 is coupled to the filter head 210.

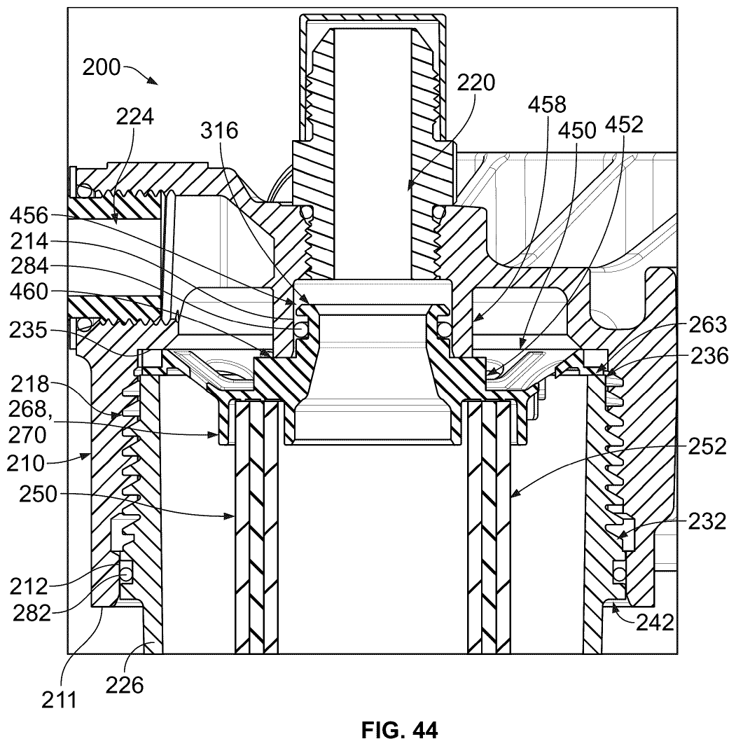

Referring now to FIG. 44, a detailed cross-sectional view of a portion of the filter assembly 200 including an alternative filter element is shown. The alternative filter element is similar to the filter element 250 and includes an alternative endplate 450 that is similar to the first endplate 260. Accordingly, like numbering is used to denote like parts between the alternative filter element and the filter element 250. A difference between the alternative endplate 450 and the first endplate 260 is that the alternative endplate 450 includes a spacer flange 452 that extends axially away from the alternative endplate 450 in a direction away from the second endplate 290. The spacer flange 452 also extends circumferentially around the center pipe 316.

When the alternative filter element is positioned within the shell 238 and the shell 238 is coupled to the filter head 210, the center pipe 316 extends into a filter head inlet opening 456 defined by an annular inlet wall 458 extending axially in a direction toward the second endplate 290. The annular inlet wall 458 includes the second sealing surface 214, a first inlet wall end 457, and a second inlet wall end 459. The spacer flange 452 includes a diameter that is greater than a diameter of the second sealing surface 214.

The spacer flange 452 has a first (e.g., radial) dimension that extends radially away from the center pipe 316 and a second (e.g., axial) dimension that extends axially away from the endplate end wall 262. The spacer flange 452 extends axially in a direction away from the second endplate 290, the axial dimension being a predetermined length away from the endplate end wall 262 such that the spacer flange 452 spaces a top portion of the shell 238 away from the filter head 210. More specifically, the spacer flange 452 spaces the shell sealing channel 232 away from the recessed wall 216 by the predetermined length. The spacer flange 452 substantially prevents the filter cartridge 230 form being further inserted (e.g., threaded) such that the first sealing member 282 and the shell sealing channel 232 are substantially prevented from moving into the recessed wall 216 of the filter head 210. That is, when the filter element 250 is installed in the shell 238, the shell threads 248 engage with the filter head threads 218 until threading is prevented by engagement between the spacer flange 452 and the second inlet wall end 459 of the inlet wall 458. The spacer flange 462 is structured to form a gap between the alternative endplate 450 and the end surface 235

In some embodiments, the spacer flange 452 is unitarily formed with the alternative endplate 450. In some embodiments, the spacer flange 452 is removably coupled to the alternative endplate 450. In some embodiments, the alternative endplate 450 includes both the first spacing member 266 and the spacer flange 452. In some embodiments, the alternative endplate 450 does not include the first spacing member 266.

The spacer flange 452 may be included with any of the endplates (e.g., the first endplate 260, 360, 400, 410, 420, 430, 450; alternative endplate 261) shown and described in FIGS. 13-43 of the present application. For example, the first endplate 260 shown in FIGS. 19-21 may include the spacer flange 452 and the first spacing member 266.

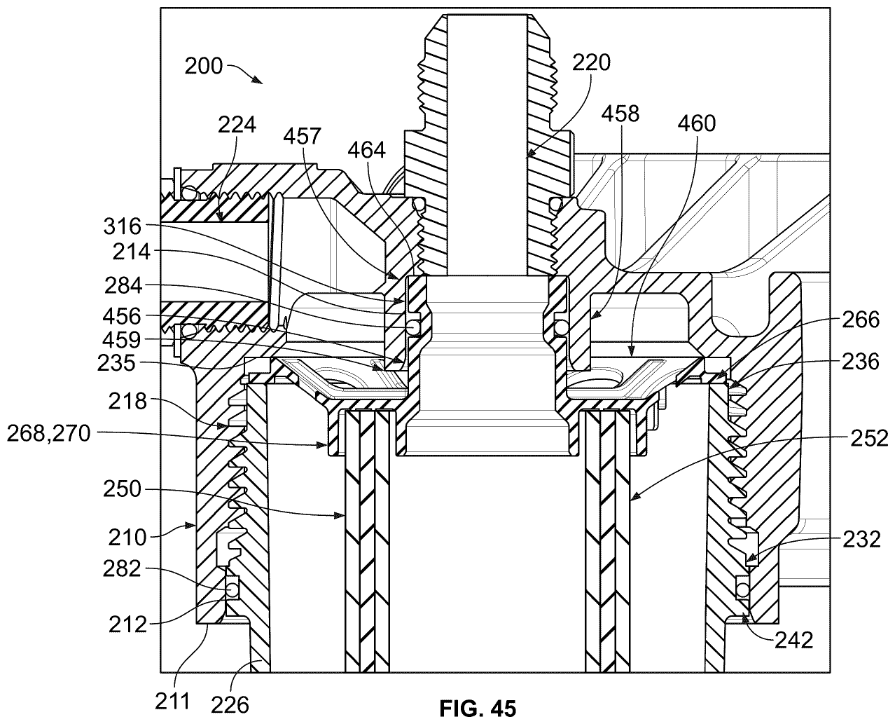

Referring now to FIG. 45, a detailed cross-sectional view of a portion of the filter assembly 200 including another alternative filter element is shown. The alternative filter element is similar to the filter element 250 and includes an alternative endplate 460 that is similar to the alternative endplate 450. Accordingly, like numbering is used to denote like parts between the alternative endplate 450 and the alternative endplate 460. A difference between the alternative endplate 450 and the alternative endplate 460 is that the alternative endplate 460 includes an extended center pipe 316 that is configured to engage the filter head 210.

When the alternative filter element is positioned within the shell 238 and the shell 238 is coupled to the filter head 210, the center pipe 316 extends into a filter head inlet opening 456 and engages an end surface 464 of the filter head 210 positioned proximate to the first inlet wall end 457 and positioned radially within the inlet wall 458.

The center pipe 316 of the alternative endplate 460 has an axial dimension that extends axially away from the endplate end wall 262. The center pipe 316 extends axially in a direction away from the second endplate 290, the axial dimension being a predetermined length away from the endplate end wall 262 such that the center pipe 316 spaces a top portion of the shell 238 away from the filter head 210. More specifically, the center pipe 316 spaces the shell sealing channel 232 away from the recessed wall 216 by the predetermined length. For example, when the filter cartridge 230 is coupled to (e.g., threaded onto) the filter head 210, the center pipe 316 is positioned within the inlet wall 458 and is structured to engage the filter head 210 to prevent further axial movement of the filter cartridge 230 in a direction toward the 220. The center pipe 316 is structured to form a gap between the alternative endplate 460 and the end surface 235

The center pipe 316 substantially prevents the filter cartridge 230 form being further inserted (e.g., threaded) such that the first sealing member 282 and the shell sealing channel 232 are substantially prevented from moving into the recessed wall 216 of the filter head 210. That is, when the filter element 250 is installed in the shell 238, the shell threads 248 engage with the filter head threads 218 until threading is prevented by engagement between the center pipe 316 and the end surface 464.

In some embodiments, the center pipe 316 is unitarily formed with the alternative endplate 460. In some embodiments, the center pipe 316 is removably coupled to the alternative endplate 460. In some embodiments, the alternative endplate 460 includes both the first spacing member 266 and the center pipe 316 where the center pipe 316 is structured to engage the end surface 464. In some embodiments, the alternative endplate 460 includes the first spacing member 266, the spacer flange 452, and the center pipe 316. In some embodiments, the alternative endplate 460 does not include the first spacing member 266 or the spacer flange 452.

The center pipe 316 structured to engage the end surface 464 may be included with any of the endplates (e.g., the first endplate 260, 360, 400, 410, 420, 430, 450; alternative endplate 261) shown and described in FIGS. 13-44. For example, the first endplate 260 shown in FIGS. 19-21 may include the center pipe structured to engage the end surface 464.

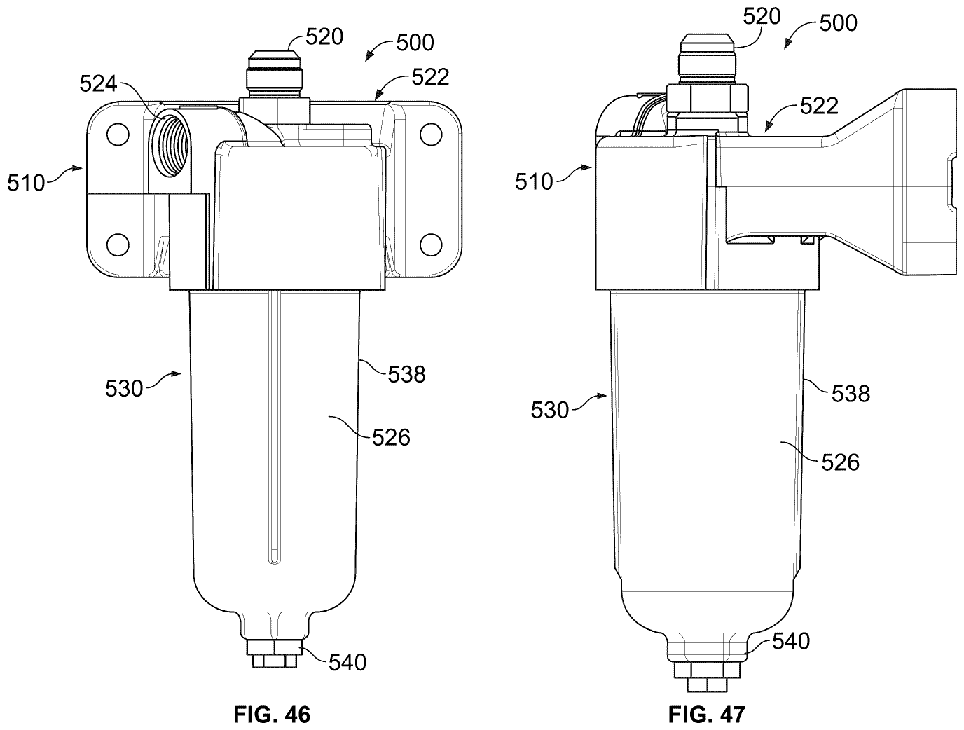

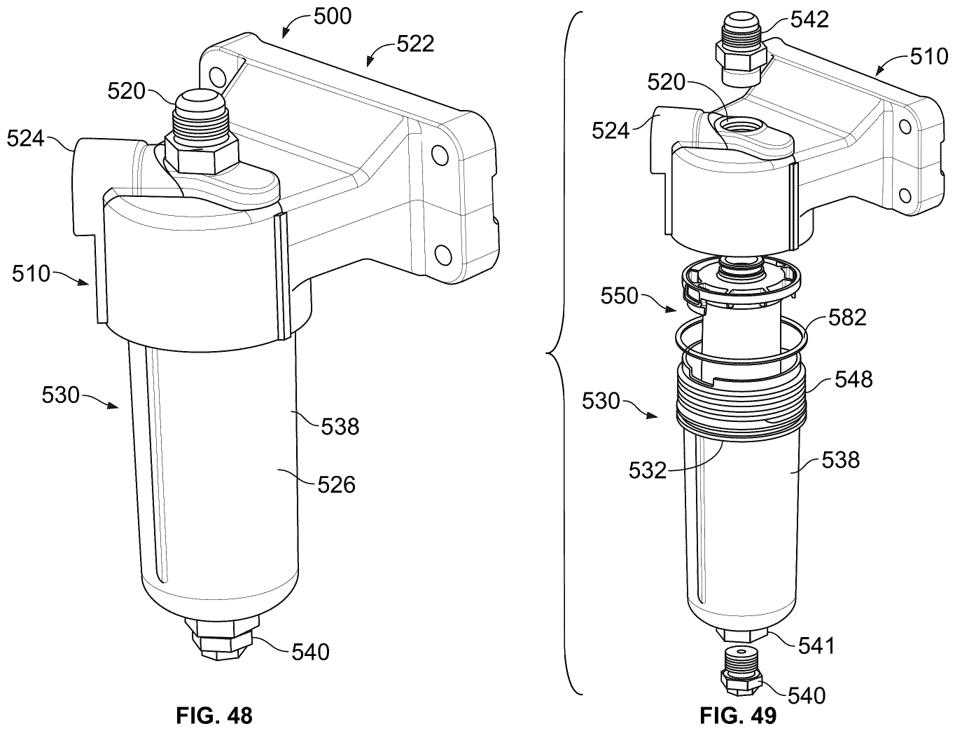

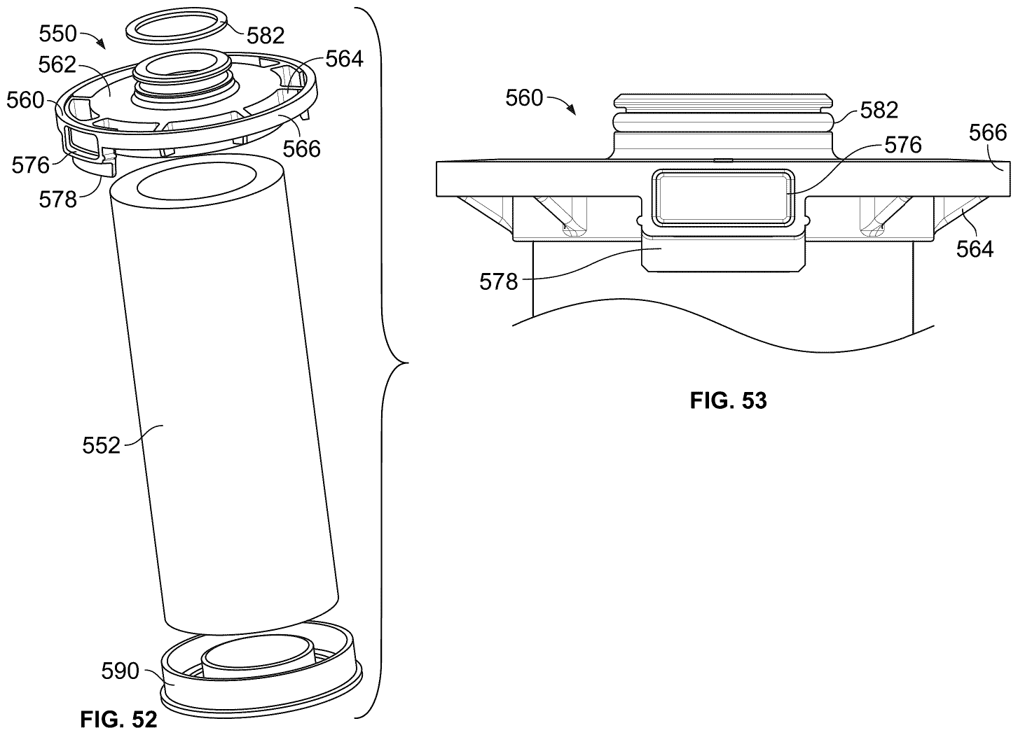

Referring now to FIGS. 46-56, various views of a filter assembly 500 and a filter element 550 usable therein are shown, according to an example embodiment. As shown in FIGS. 46-49, the filter assembly 500 includes a filter head 510 and a filter cartridge 530 removably coupled to the filter head 510. It should be understood that the filter assembly 500 may include more or fewer components than as shown in FIGS. 46-49.

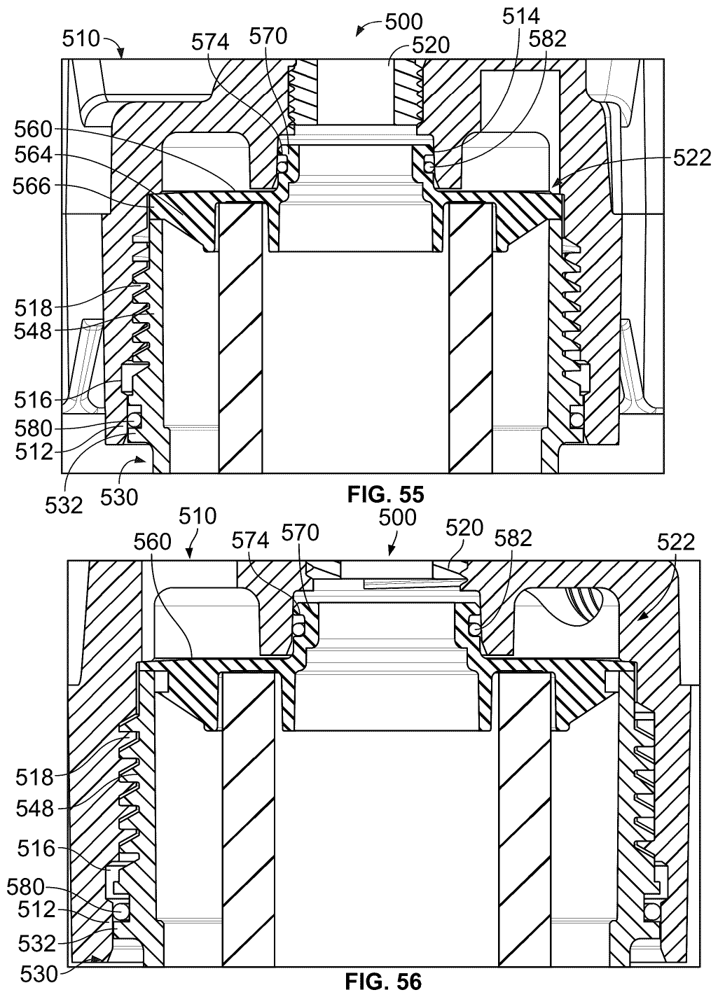

The filter head 510 includes a filter head wall 522. The filter head 510 includes a first port 520 and a second port 524. One of the first port 520 and the second port 524 is an inlet, and the other of the first port 520 and the second port 524 is an outlet. For example, in particular embodiments, the first port 520 is an inlet for provided a dirty or unfiltered fuel to the filter assembly 500, and the second port 524 is an outlet for providing a filtered fuel to a downstream component such as an engine. The filter head 510 also includes one or more inward facing filter head threads 518 (as shown in FIG. 55). The filter head threads 518 are configured to receive one or more outward facing threads, such as one or more outward facing treads shown as shell threads 548 of the shell 538 (described herein below).

The filter cartridge 530 includes a shell 538, a drain plug 540, and a filter element 550. The shell 538 has a shell wall 526. The shell 538 defines an internal volume. In various embodiments, the filter element 550 is removably positioned within the shell 538. The shell 538 is structured to receive the filter element 550 at least partially within the internal volume. The drain plug 540 may be removably coupled to the shell 538. When the drain plug 540 is coupled to the shell 538, the drain plug 540 substantially prevents a fluid (e.g., fuel, water, etc.) from flowing out of the shell 538. When the drain plug 540 is removed from the shell 538, a fluid may flow out of the shell 538 through a drain plug port 541. As shown in FIG. 49, the filter assembly 500 also includes a first sealing member 582 (described herein below).

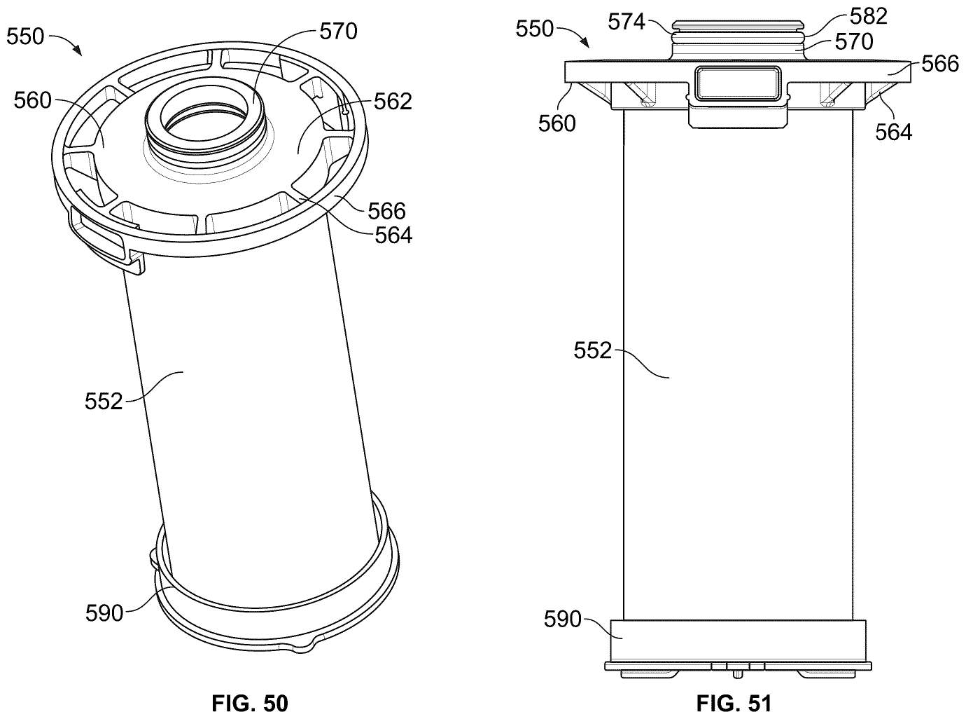

Referring now to FIGS. 50-53, the filter element 550 includes a filter media 552 fitted between a first endplate 560 and a second endplate 590. For example the first endplate 560 is coupled to the filter media 552 at a filter media first end, and the second endplate 590 is coupled to the filter media 552 at a filter media second end, opposite the first end. The filter media 552 may include one or more media layers such as a pleated and/or a woven or non-woven filter media, a hydrophobic screen, and/or any other suitable filter media layer.

The first endplate 560 of the filter element 550 includes an endplate end wall 562, an annular spacing member 566, and an axial channel 570. The first endplate 560 is fixed to the filter media 552 at the endplate end wall 562.

The first spacing member 566 has a first dimension that extends circumferentially around the endplate end wall 562 and a second dimension that extends axially away from the endplate end wall 562. The first spacing member 566 extends in the second dimension a predetermined length away from the endplate end wall 562 such that the first spacing member 566 spaces a top portion of the shell 538 away from the filter head 500 when the filter element 550 is installed in the filter assembly 500 as shown in FIG. 55 and described herein below. The first spacing member 566 is spaced away from the endplate end wall 562 by one or more ribs 564. The ribs 564 extend radially away from the endplate end wall 562 towards the first spacing member 566 and contact an inner surface of the first spacing member 566 such that the ribs 564 support the first spacing member 566.

The axial channel 570 extends axially way from the endplate end wall 562. The axial channel 570 is in fluid communication with the first port 520. The axial channel 570 includes an endplate sealing channel 574. The endplate sealing channel 574 is structured to receive a second sealing member 584 therein. The second sealing member 584 is structured to form a circumferential seal between the first endplate 560 (e.g., at the endplate sealing channel 574) and the filter head 510 (e.g., at a second sealing surface 514 shown in FIG. 55).

The first endplate 560 also includes a radial flange 576. The radial flange 576 extends radially outward from the first spacing member 566. An axial flange 578 extends axially away from the radial flange 576. The axial flange 576 and the radial flange 578 define a grip surface for a user to grip the filter element 550.

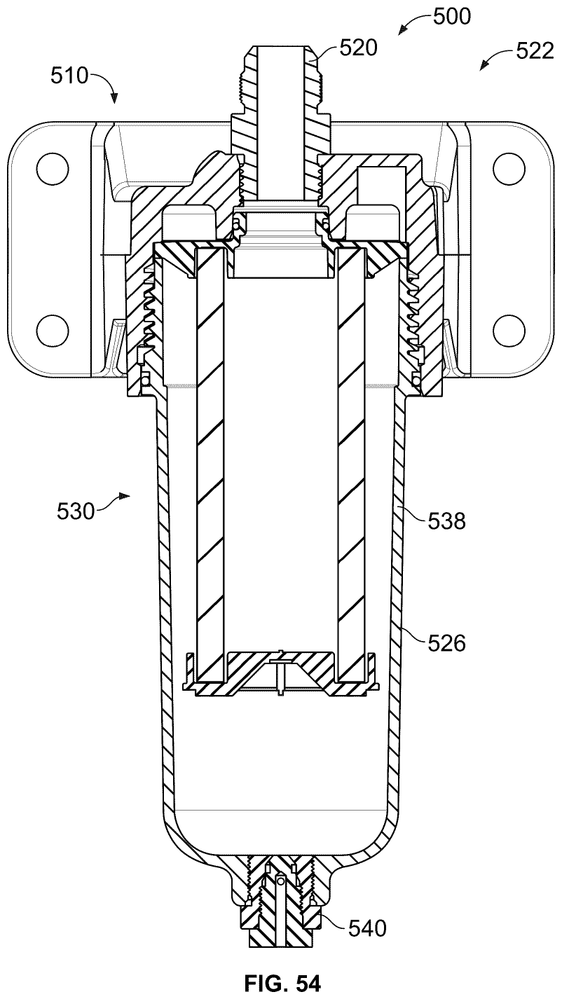

Referring now to FIGS. 54 and 55, cross-sectional views of the filter assembly 500, are shown with the filter element 550 installed (e.g., within the shell 538). As shown, the filter head 510 includes a first sealing surface 512, a second sealing surface 514, a recessed wall 516, and the filter head threads 518. The filter head 510 also includes the first port 520 and the second port 124 (described herein above). The first sealing surface 512 is structured to form a first circumferential, radially-directed seal with a sealing member (e.g., the first sealing member 582 in the form of an o-ring gasket or the like). The second sealing surface 514 is structured to form a second circumferential seal with a sealing member (e.g., the second sealing member 584 in the form of an o-ring gasket or the like). The recessed wall 516 is a portion of a side wall of the filter head 510 that is positioned farther away from the filter element 550 (when installed) than the portion of the filter head defined by the first sealing surface 512. In the embodiment shown in FIG. 55, the first sealing surface 512 and the recessed wall 516 are positioned axially below the filter head threads 518.

In some embodiments, when the first circumferential seal is formed by the first sealing member 582, at least one of an upstream component and a downstream component are structured to operate normally. For example, at least one of the upstream component and the downstream component may detect the presence of the seal by detecting a fluid pressure within a predetermined threshold. The first circumferential seal maintains the fluid pressure by substantially preventing a fluid from entering the internal volume from outside the filter assembly 500 and/or escaping from the internal volume 534 to the outside of the filter assembly 500. In other embodiments, when the first circumferential seal is formed by the first sealing member 582, a user may visually inspect the filter assembly 500 to verify that no fluid is leaking out of the filter assembly 500.

The shell 538 includes a shell sealing channel 532 configured to receive the first sealing member 582 therein. The first sealing member 582 is structured to form a first circumferential seal between the shell 538 (e.g., at the shell sealing channel 532) and the filter head 510 (e.g., at the first sealing surface 512). Accordingly, the first circumferential seal substantially prevents a fluid from flowing between the shell 538 and the filter head 510. The shell scaling channel 532 is positioned axially below the shell threads 548.

When the filter element 550 is installed, the first spacing member 566 spaces the shell sealing channel 532 away from the recessed wall 516 by a predetermined. For example, when the filter cartridge 530 is threaded onto the filter head 110, the first spacing member 566 contacts the filter head wall 522 such that the first sealing member 582 is aligned with the first sealing surface 512. The first spacing member 566 substantially prevents the filter cartridge 530 form being further threaded such that the first sealing member 582 and the shell sealing channel 532 are substantially prevented from moving into the recessed wall 516 of the filter head 510. That is, when the filter element 550 is installed in the shell 538, the shell threads 548 engage with the filter head threads 518 until prevented by the first spacing member 566.

FIG. 56 is a detailed cross-sectional view of the filter assembly 500 shown without a filter element 150. When the first spacing member 566 is not present, the shell threads 548 engage with the filter head threads 518 until the first sealing member 582 is positioned within the recessed wall 516. The first sealing member 582 does not form a seal with the recessed wall 516 such that a fluid may flow between the shell 538 and the filter head 510.

In some embodiments, when the first circumferential seal is not formed by the first sealing member 582, at least one of an upstream component and a downstream component are structured to be prevented from operating normally. For example at least one of the upstream component and the downstream component may detect the absence of the seal by detecting a fluid pressure outside of a predetermined threshold. The fluid pressure within the filter assembly 500 cannot be maintained because the outside of the filter assembly 500 is in fluid communication with the internal volume. In other embodiments, when the first circumferential seal is not formed by the first sealing member 582, a user may visually inspect the filter assembly 500 to determine that a fluid is leaking out of the filter assembly 100.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A filter assembly comprising:
a filter head comprising one or more filter head threads;
a filter cartridge comprising:
a shell having a shell wall defining an internal volume;
a collar disposed around and coupled to the shell, the collar comprising one or more collar threads threadably engaged with the one or more filter head threads; and
a filter element disposed within the internal volume and comprising:
filter media; and
a first endplate coupled to the filter media at a filter media first end, the first endplate comprising:
an endplate end wall;
a first spacing member extending axially away from the endplate end wall such that the first spacing member spaces the shell away from the filter head when the filter element is installed in the shell; and
a second spacing member extending axially away from the endplate end wall, wherein the first spacing member extends radially away from the second spacing member.

2. The filter assembly of claim 1, wherein the filter head comprises a filter head wall defining a filter head sealing surface and a recessed wall.

3. The filter assembly of claim 2, wherein the filter head sealing surface is positioned axially above the filter head threads, and the recessed wall is positioned axially above the filter head sealing surface.

4. The filter assembly of claim 2, wherein the shell comprises a shell sealing channel structured to receive a sealing member therein.

5. The filter assembly of claim 4, wherein the shell comprises a plurality of axial flanges that each extend axially away from the shell sealing channel, each of the plurality of axial flanges contacting a filter head wall when the shell is coupled to the filter head and when the filter element is not installed in the shell, such that the axial flanges space the shell away from the filter head.

6. The filter assembly of claim 4, wherein the first spacing member spaces the shell away from the filter head by a predetermined distance such that the shell sealing channel aligns with the filter head sealing surface such that the sealing member forms a circumferential seal between the shell sealing channel and the filter head sealing surface.

7. The filter assembly of claim 6, wherein the collar comprises a collar axial channel that fluidly couples the internal volume with an exterior of the filter assembly.

8. The filter assembly of claim 7, wherein the circumferential seal prevents fluid communication between the internal volume and an exterior of the filter assembly through the collar axial channel.

9. The filter assembly of claim 1, wherein the second spacing member extends circumferentially at least partially around the filter media, the second spacing member contacting the shell such that the second spacing member locates the filter element at a center of the internal volume.

10. A filter assembly comprising:
a filter head comprising one or more filter head threads;
a filter cartridge comprising:
a shell having a shell wall defining an internal volume; and
a filter element disposed within the internal volume and comprising:
filter media; and
a first endplate coupled to the filter media at a filter media first end, the first endplate comprising:
an endplate end wall; and
a first spacing member spaced radially away from the endplate end wall and extending axially away from the endplate end wall such that the first spacing member spaces the shell away from the filter head when the filter element is installed in the shell.

11. The filter assembly of claim 10, wherein the first endplate comprises a plurality of ribs extending radially away from the endplate end wall towards the first spacing member such that the plurality of ribs support the first spacing member; and
wherein the first spacing member extends circumferentially around the endplate end wall.

12. The filter assembly of claim 10, wherein the filter head comprises a filter head wall defining a filter head sealing surface and a recessed wall.

13. The filter assembly of claim 12, wherein the recessed wall is positioned axially below the filter head threads, and wherein the filter head sealing surface is positioned axially below the recessed wall.

14. The filter assembly of claim 12, wherein the shell comprises a shell sealing channel structured to receive a sealing member therein.

15. The filter assembly of claim 14, wherein the first spacing member spaces the shell away from the filter head by a predetermined distance such that the shell sealing channel aligns with the filter head sealing surface such that the sealing member forms a circumferential seal between the shell sealing channel and the filter head sealing surface.

16. A filter element comprising:
a media pack; and
a first endplate coupled to a first media end, the first endplate comprising:
a first spacing member;
a sloped wall extending radially inward from the first spacing member, the sloped wall having a frustoconical shape; and
a plurality of apertures extending through the sloped wall, each of the plurality of apertures defining a center axis at an angle relative to a central axis of the media pack.

17. The filter element of claim 16, wherein the sloped wall tapers to a smaller diameter as the sloped wall extends into the media pack.

18. The filter element of claim 16, wherein each of the plurality of apertures is positioned radially outward from the media pack.

19. The filter element of claim 16, wherein the second endplate further comprises a media channel extending axially from the first endplate, the media channel positioned radially inward of the plurality of apertures.

20. The filter element of claim 16, wherein the sloped wall extends at a first angle of between 30-60°, inclusive, relative to the central axis of the media pack.
